(19) United States
(12) Patent Application Publication
(10) Pub. No.: US 2007/0228856 A1
(43) Pub. Date: Oct. 4, 2007

(54) Efficiency magnetic motor

(76) Inventors: John Bates, Huntsville, AL (US); Autry King, Hollypond, AL (US); Thomas Gunthery, Cullman, AL (US)

Correspondence Address: FOLEY AND LARDNER LLP;SUITE 500, 3000 K STREET NW, WASHINGTON, DC, 20007, US

(21) Appl. No.: 11/241,736

(22) Filed: Sep. 28, 2005

Related U.S. Application Data
(63) Continuation-in-part of application No. PCT/US04/09588, filed on Mar. 29, 2004.
(60) Provisional application No. 60/458,979, filed on Mar. 28, 2003.

(51) Int. Cl. H02K 37/00; H02K 47/00; H02K 21/12

(52) U.S. Cl. 310/114; 310/261; 310/112; 310/156.38; 310/46

(57) ABSTRACT

A magnetic motor includes a rotating component having at least one magnet arranged on at least one spoke or rotating disc. The magnetic motor also includes a coil disposed adjacent to the rotating component and configured to generate an electromagnetic field. The magnet is aligned on the spoke or rotating disc so that the electromagnetic field generated by the coil acts on a magnetic field generated by the magnet thereby causing the spoke or rotating disc to move.

The present application is a Continuation-In-Part of PCT Application Serial No. PCT/US2004/009588, filed on Mar. 29, 2004, which claims priority to U.S. Provisional Application No. 60/458,979, filed on Mar. 28, 2003, by John Bates, Autry King and Thomas Guthery, the contents of all of these application being incorporated by reference in their entirety.

### SUMMARY OF THE INVENTION

According to an embodiment of the present invention, a magnetic motor, includes a rotor, wherein the rotor includes a center of rotation, magnets, wherein the magnets are mounted on ends of the rotor, and at least one coil, wherein the at least one coil is arranged to be energized by a source of power to move the rotor through interaction of the at least one coil with the magnets and accelerate the rotor to a predetermined operating speed, wherein the at least one coil is arranged to have an electrical current induced in the at least one coil by the magnets while the rotor is moving.

According to an embodiment of the present invention, a power generating system includes a rotor, wherein the rotor includes a center of rotation, magnets, wherein the magnets are mounted on ends of the rotor, and at least one coil, wherein the at least one coil is arranged to be energized by a source of power to move the rotor through interaction with the magnets and accelerate the rotor to a predetermined operating speed, wherein the at least one coil is arranged to have an electrical current induced in the at least one coil by the magnets while the rotor is moving, wherein the system is arranged to power a vehicle, a residence, an industrial facility, industrial equipment, medical equipment, appliances, or farm equipment.

According to an embodiment of the present invention, a method of operating a magnetic motor includes the steps of providing a magnetic motor that includes a rotor that includes a center of rotation, magnets that are mounted on ends of the rotor, and at least one coil, wherein the at least one coil is arranged to be energized by a source of power to move the rotor through interaction with the magnets and accelerate the rotor to a predetermined operating speed, wherein the at least one coil is arranged to have an electrical current induced in the at least one coil by the magnets while the rotor is moving, energizing at least one coil to move the rotor through interaction of the at least one coil with the magnets and accelerate the rotor to a predetermined operating speed, periodically energizing at least one coil with a source of power to move the rotor through interaction of the at least one coil with magnets to maintain the rotor at the predetermined operating speed, collecting current from at least one coil arranged to have an electrical current induced in the at least one coil by the magnets while the rotor is moving, and arranging the at least one coil arranged to have an electrical current induced in the at least one coil by the magnets while the rotor is moving as the source of power.

### BRIEF DESCRIPTION OF THE DRAWINGS

FIG. 1 is a plan view of a first embodiment of the present invention.

FIG. 2 is an electrical schematic of a first embodiment of the present invention.

FIG. 3 is another embodiment of the present invention.

FIG. 4 is a photograph of the first embodiment of the present invention.

FIG. 5 is another photograph of the first embodiment of the present invention.

FIG. 6 is another photograph of the first embodiment of the present invention.

FIG. 7 is another photograph of the first embodiment of the present invention.

FIG. 8 is another photograph of the first embodiment of the present invention.

FIG. 9 is another photograph of the first embodiment of the present invention.

FIG. 10 is another photograph of the first embodiment of the present invention.

FIG. 11 is another photograph of the first embodiment of the present invention.

FIGS. 12a-f are additional photographs of the first embodiment of the present invention.

FIGS. 13a-l are views of a working example of the present invention.

FIGS. 14a-h are views of a working example of the present invention.

FIGS. 15a-m are additional views of a working example of the present invention.

### DETAILED DESCRIPTION

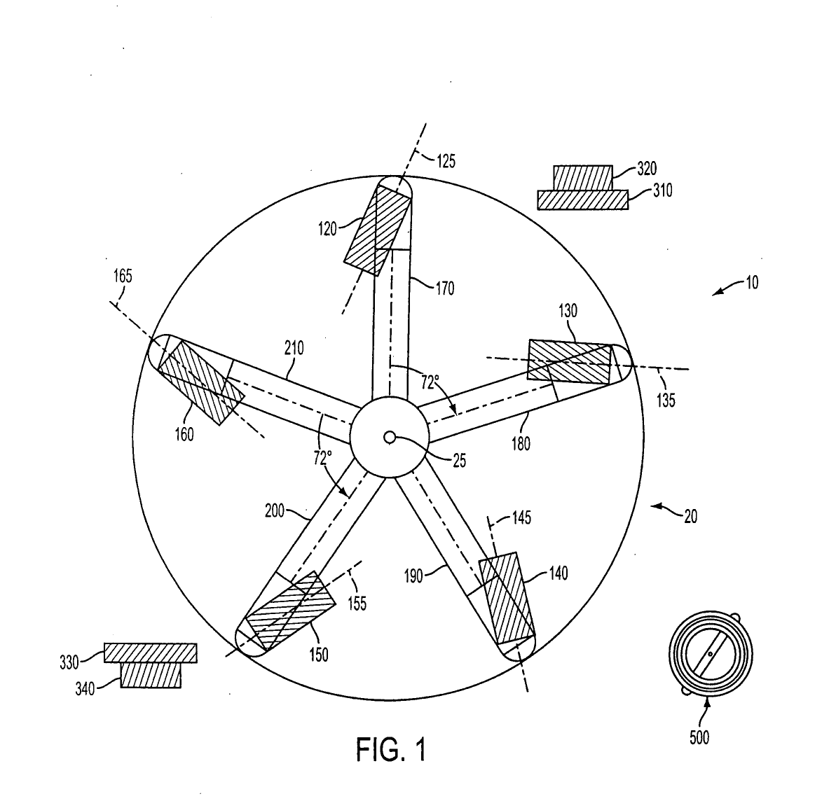

As shown in FIG. 1, the first embodiment of the present invention comprises an improved efficiency magnetic motor 10. The magnetic motor 10 has permanent magnets 120, 130, 140, 150 and 160 arranged on spokes 170, 180, 190, 200 and 210 converging at a central point. A rotor with a center of rotation and ends may be used instead of the arrangement of spokes or in addition to the arrangement of spokes. It is noted that while five magnets can be used to practice one embodiment of the present invention, other embodiments of the present invention can utilize 4, 3, 2 or even 1 permanent magnet as well as 6, 7, 8, 9, 10 or more magnets. Indeed, the present invention can be practiced with virtually any number of permanent magnets. Also, non-permanent magnets can be utilized in other embodiments if it can serve the function of the permanent magnets, as is described in greater detail below. As can be seen from FIG. 1, the spokes 170 to 210 are arranged equidistant from each other. That is, each spoke is aligned at or about 72° from each other. It is noted that the spokes could be arranged in a manner where they are not equidistant from each other as well to practice other embodiments of the present invention. That is, a variety of layouts of the spokes can be utilized in various embodiments, as long as the layout will permit the present invention to be practiced. It is, however, preferred to have the spokes equidistant or about equidistant as possible.

The magnetic motor 10 has a rotating component 20 comprising the above mentioned magnets and spokes. The rotating component 20 may also be a rotor with a center of rotation. The rotating component 20 has an axis 25 about which it rotates. In an exemplary embodiment of the present invention, the rotating component 20 rotates in a plane or about substantially in a plane. However, other embodiments the present invention can utilize a rotating component that does not rotate in a plane. By way of example, the rotating component could wobble or oscillate. Furthermore, other embodiments of the present invention can be practiced with a rotating component that moves in the direction of the axis of rotation as the rotating component rotates. Still, in an exemplary embodiment of the present invention, the rotating component 20 does not move along the axis of rotation. Also, it is noted that the rotating component 20 could both wobble or oscillate and move in the direction of rotation. Thus, a variety of dynamic movement regimes of the rotating component 20 can be utilized to practice the present invention providing that the rotating component 20 rotates.

In the embodiment shown in FIG. 1, the permanent magnets have an axis that is 18° from the center line of the spokes where the spokes are arranged equidistant from each other. This was arranged so the magnets and coil faces were parallel.

The permanent magnets 120 through 160 have axis 125 to 165 that span the longitudinal direction of the permanent magnets and that are aligned with the center of the magnets or the center of magnetic force of the magnets as shown in FIG. 1. For example, longitudinal axes of the magnets may be arranged at an angle with respect to a line passing proximate a magnet and passing between the center of rotation and an edge of the rotor. In the first preferred embodiment of the present invention, this axis is approximately 18° from a line drawn from the center of rotation 25 of the rotating component 20 to the center of an end of a permanent magnet. However, it is noted that embodiments of the present invention can be utilized with permanent magnets that are aligned less than 18° with this line from the center of rotation to the permanent magnet, as well as magnets that are aligned more than 18° from this line to the center of rotation. By way of example, it is believed that magnets that are offset by an angle of about 0, 1, 2, 3, 4, 5, 6, 7, 8, 9, 10, 11, 12, 13, 14, 15, 16, 17 and 18 degrees as well as angles in any range in between the just listed angles in increments of 0.01° (e.g., 0.01, 0.02, 0.03, 0.04, etc.), can be used to practice the present invention. Furthermore, it is believed that magnets having an alignment of about 19, 20, 21, 22, 23, 24, 25, 26, 27, 28, 29 and 30 degrees as well as angles in between the just listed angles in increments of 0.01 can be used to practice the present invention. Indeed, a wide range of angular alignments can be used to practice the present invention. Alignments such as 30°, 35°, 40°, 45°, 50°, 55°, 60°, 65°, 70°, 75°, 80°, 85° and 90° in increments of 0.01° in any range in between can be used to practice the present invention. Thus, the angle of the permanent magnets with respect to the center of rotation is variable, as long as the angle will permit the present invention to be practiced. Also, in an exemplary embodiment, the magnets are held substantially stationary with respect to the center of rotation. However, other embodiments of the invention utilize magnets that are not stationary with respect to the center of rotation. That is, the magnets move (change orientation, distance, etc.) with respect to the center of rotation. However, some optimized embodiments of the present invention can be obtained by magnet positioning. Still further, magnets having no clear longitudinal axis can be used to practice the present invention (e.g., symmetrical magnets about all axis). It is believed that any size or shape magnet can be used providing that the magnets will allow the present invention to be sufficiently practiced.

In an exemplary embodiment, standard iron magnets can be used to practice the invention. In other embodiments, different types of magnets can be utilized. By way of example, rare earth magnets can be used. Basically, any type of magnet can be utilized providing that the magnets will allow the present invention to be sufficiently practiced.

In the embodiment shown in FIG. 1, the motor has two coils, 310 and 330, that are supported by support members 320 and 340. In an embodiment, the motor includes at least one coil. These coils, in an exemplary embodiment, are standard coils that produce an electromagnetic field when a current is run through the coils. In the embodiment shown in FIG. 1, the coils 310 and 330 are about 180° from each other and positioned on either side of the axis of rotation of the rotating component 20. The coils 310 and 330 are positioned such that they can properly generate a magnetic field that will act on the field created by the permanent magnets of the rotating component 20, thus causing the rotating component to rotate. In an exemplary embodiment, the coils 310 and 330 are vertically aligned with respect to the plane of rotation of the rotating component 20. That is, the axis of winding lies on a plane that is about normal to the plane of rotation of component 20. However, in other embodiments of the present invention, the coils can be horizontally aligned with the plane of rotation. In such instances, the permanent magnets 120 to 160 could be aligned to maximize or at least to provide sufficient electromagnetic force between the permanent magnets and the coil. Thus, any alignment of the coils 310 and 330 with respect to the plane of rotation of the rotating component can be utilized to practice the present invention providing that the coils can function to provide a magnetic field that will act on the permanent magnets and cause rotating component 20 to rotate. It is also noted that it is believed that any alignment of the permanent magnets can be utilized to practice the invention as long as the magnets are aligned so that they will respond to the magnetic field produced by the coils in a manner that will result in a force that will result in a rotation of the rotating component 20.

In the embodiment shown in FIG. 1, the coils are primary coils of a commercially available transformer. However, the present invention can be practiced utilizing other types coils as well. Indeed, any coil that will produce a sufficient magnetic field can be utilized to practice the present invention. However, in the first embodiment of the present invention, a heavy wire coil is utilized, as this will result in low resistance and thus result in a lower impedance of the current flow through the coils, producing a superior magnetic field. However, light wire coils having a higher resistance can be utilized as well. Again, it is repeated that basically any coil can be utilized to practice the present invention providing that it produces a sufficient electromagnetic field to rotate the rotating component 20. Still further, the present invention is not restricted to the use of coils. Any device that can create an electromagnetic field that will cause rotating component 20 to rotate can be used in place of and/or with the coils.

As can be seen from FIG. 1 and discussed above, the experimental embodiment of the present invention utilizes two coils 310 and 330 (driver coils) to generate a magnetic field to rotate the rotating component 20. It is noted that some embodiments of the present invention can utilize only a single coil while other embodiments of the present invention could utilize more than two coils. By way of example and not by way of limitation, 3, 4, 5, 6, 7, 8, 9, 10 and more coils can be utilized to practice the invention. Indeed, a range of coils from 1 to almost an unlimited number and ranges of increments of 1 or more in between can be used to practice the present invention. Thus, the number of coils is not a limiting factor. In other embodiments of the present invention, the coils can wrap around or substantially around the entire rotating component 20. In an exemplary embodiment of the present invention, the coils 310 and 330 are about aligned with a plane going through the center of gravity of the magnets. However, in other embodiments of the present invention, the coils can be above or below this plane. Furthermore, one coil could be above this plane while another coil could be below this plane, or in the case of where three or four or more coils are utilized in the present invention, one or more coils could be above and two or more coils could be below, or three or more coils could be below or two or more coils could be above and one could be below, etc. Basically, any number of coil layouts could be used to practice the present invention. This is likewise the case with the magnets (i.e., the magnets do not have to lie on the same plane).

In an exemplary embodiment of the present invention, the axis of wrapping of the coils is directed towards the axis rotation of the rotating component 20. That is, the axis of wrapping of the coils passes through or closely passes the center of rotation. However, in other embodiments of the present invention, the axis of wrapping does not pass through the center of rotation of the rotating component 20. Furthermore, in an exemplary embodiment of the present invention, the axis of wrapping of the coils lies in a plane that is substantially parallel to the plane of the rotating component 20. However, in other embodiments of the present invention, the axis is not on such a plane. Thus, a wide variety of alignment angles of the coils can be used to practice the present invention, providing that the coils can produce a magnetic field that is suitable to generate a force that will rotate the rotating component. Still further, it is noted that in other embodiments of the present invention, such as the one shown in FIG. 1, the axis of coil wrapping is angled from the center of rotation 25 of the rotating component 20.

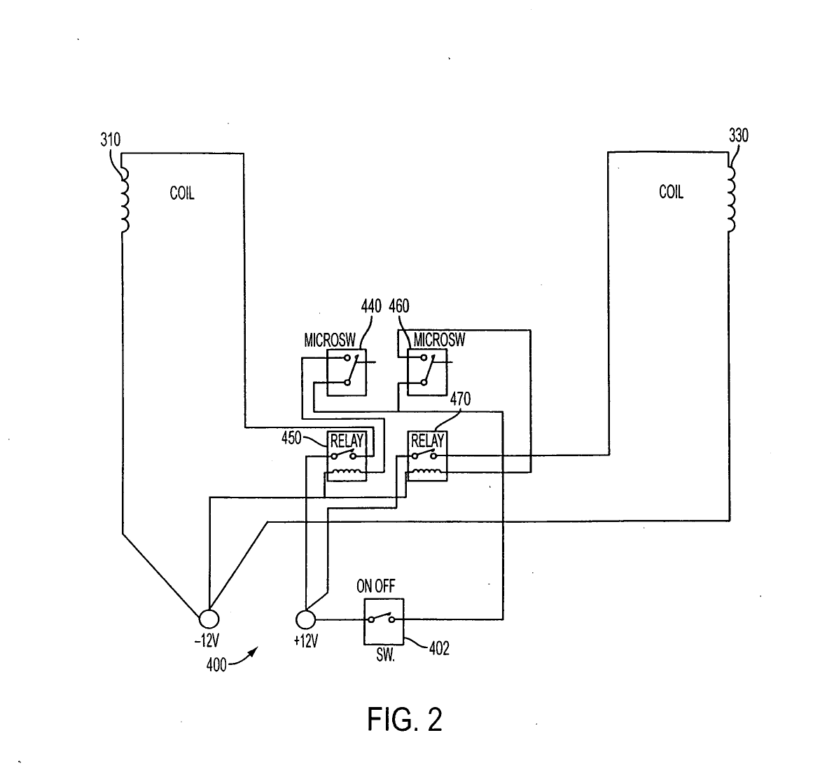

In the experimental embodiment of the present invention, the coils 310 and 330 are energized by a 12-volt DC battery 400, as can be seen in FIG. 2. FIG. 2 shows a circuit diagram of an embodiment of the present invention. As can be seen, in the first embodiment, the motor 10 is powered by a 12 volt battery 400. In FIG. 2, on/off switch 402 allows the circuit to be opened or closed. Still further, an exemplary embodiment of the present invention utilizes microswitches 440 and 460 that are connected electrically to relays 450 and 470, respectively. When microswitches 440 and 460 are closed, current is permitted to pass through the switches to relays 450 and 470, respectively, thus closing the relays. When relays 450 and 470 are closed, current is permitted to flow to both the coils. It is noted that microswitches 440 and 460 do not have to be opened and closed at the same time. Indeed, in some embodiments of the present invention, microswitch 440 will be opened and microswitch 460 will be closed at a given time, and vice versa. The same is the case for their respective relays 450 and 470. Thus, when microswitch 440 is closed, causing relay 450 to be closed, current flows to coil 310. Still further, when microswitch 460 is closed, causing relay 470 to be closed, current flows to coil 330. It is noted that while the embodiment shown in FIG. 2 shows two microswitches and two relays, respectively, other embodiments of the present invention could utilize more or less microswitches and relays, just as other embodiments can utilize more or less coils.

In an exemplary embodiment of the present invention, there is a micro switch and relay for every coil. In other embodiments of the present invention, more microswitches and relays per coil could be present as well as fewer microswitches and relays per coil. Thus, the present invention can be practiced with a variety of microswitches or relays, providing that the microswitch and relay regime can be used to sufficiently practice the present invention. Furthermore, the present invention can be practiced with a wide variety of types of microswitches and relays. Basically, any type of switch that can be used to open and close a circuit can be used to practice in the invention. Indeed, in some embodiments of the present invention, relays and/or microswitches may not be needed, depending on the design, as long as there is a device available that can open and close the circuit. In another embodiment of the present invention, devices that do not completely open or completely close the circuit, but instead serve to restrict the flow of current to the circuit, with or without opening and closing the circuit, can be used to practice the present invention. By way of example, a rheostat that significantly increases and decreases the voltage to the currents could be used to practice the present invention in lieu of switches.

Thus, some embodiments of the present invention can be practiced with any device adapted, in some manner, to energize and de-energize the coils and/or to substantially increase or decrease the current flow to the coils.

As noted above, in an exemplary embodiment, a 12 volt DC battery 400 is used to power the system. However, other embodiments of the present invention can be utilized with a battery of higher voltage or of lower voltage. Furthermore, other embodiments of the present invention can be practiced with an alternating current power source as well. By way of example only and not by way of limitation, an alternator could be incorporated into the circuit of the electric motor.

In the embodiment shown in FIGS. 1 and 2, the motor 10 is configured such that microswitches 440 and 460 are closed when the permanent magnets are in close proximity to the coils 310 and/or 330. As the rotating component 20 of the embodiment shown in FIG. 1 utilizes five symmetrically spaced permanent magnets and two symmetrically spaced coils, only one magnet would be in close proximity to one coil at a given time during operation of the motor of FIG. 1. Thus, in the embodiment shown in FIG. 1, a permanent magnet is in close proximity to the coil 330 while a permanent magnet is not in close proximity to the coil 310. In such a scenario, in an exemplary embodiment, only coil 330 would be energized. That is, microswitch 440 would be closed (as would relay 450), while microswitch 460 would be open (as would relay 470). That is, battery 400 would only be energizing coil 310. However, in other embodiments, where the number of magnets are different and/or the configuration of the magnets and/or coils is different than that shown in FIG. 1, it would be possible to have two or more magnets in close proximity to a coil at the same time. Thus, by way of example, in the case where the rotating component 20 was provided with six permanent magnets evenly distributed, microswitches 440 and 460 would open and close at the same time or about the same time, thus opening and closing the relays 450 and 470 at the same time, thus energizing coils 310 and 330 at the same time. It is noted that in the case where more than two coils are used to practice the invention, and in the embodiments where multiple microswitches are used, these switches would be opened and closed at the same time and/or at different times. Also, it is noted that other embodiments of the present invention would not utilize symmetrically spaced coils and/or magnets. Thus, in the case of an odd number of magnets and/or coils, the coils could be energized at the same time or at different times.

Due to the desirability to have the coils energized only when the permanent magnets are in close proximity to the coils, the rotating component 20 of an exemplary embodiment can be configured with a device that is synchronized with the position of the magnets to open and close the microswitches 440 and 460 when desired. By way of example only and not by way of limitation, rotating component 20 could be provided with bosses that are aligned in some manner with the permanent magnets. In the experimental embodiment, the bosses are on the underside of the rotating component 20; the bosses being aligned with magnets so that as the rotating component 20 rotates, the bosses rotate as well and contact the microswitches as the bosses rotate; the microswitches only closing when the bosses are in contact with the microswitch. However, other embodiments of the present invention can be practiced where the microswitches are closed except when the bosses are in contact with the microswitch, and alternately as well (e.g., one open, one closed, etc.) However, it is noted that other types of microswitches cab be used to practice the present invention. Any type of mechanism known in the art for opening and closing microswitches can be utilized. Thus, any device or apparatus that can be utilized to open and close the microswitches to properly energize the coils of the present invention can be used. By way of example, an optical system utilizing a photosensitive eye can be used to signal to the microswitches to open and close. Further, by example, a computer can be used to manage the microswitches.

To operate the present invention, the rotating component 20 is rotated by energizing one or more of the coils, thus producing an electromagnetic field that acts on the permanent magnets of the rotating component 20. In an exemplary embodiment of the present invention, when the permanent magnet is closest to a given coil, the coil is energized after which it is de-energized. It is believed that the inertia of the rotating component 20 causes the rotating component to continue to rotate for a brief period long enough for another magnet to come into close proximity to a coil, at which point that coil is energized and then de-energized. In the first embodiment of the present invention, where two coils are utilized and there are an odd number of permanent magnets that are evenly spaced over the rotating component 20, the coils are energized intermittently. That is, one coil is energized and then de-energized, and then another coil is energized and then de-energized. This process continues until the rotating component rotates at a desired predetermined speed, which in the first embodiment of the present invention is the highest speed possible at which the rotating component will not fail (that is, the rotating component will not come apart due to the inertia forces created by the rotation). When the rotating component has achieved the desired speed in the first embodiment, which may be a speed within a range of suitable operating speeds, one coil is de-energized entirely. That is, in an exemplary embodiment of the present invention, the rotating component 20 can be kept rotating utilizing a single coil that is alternately energized and de-energized. Still, it is noted that in other embodiments of the present invention, it may be desirable to energize the coils when the permanent magnets are not in close proximity to the coils. Indeed, in some embodiments of the present invention, the coils might be energized when the magnets are furthest away from the coils, thus relying on the overall presence of the variable magnet field produced by the rotation of the magnets.

In the embodiments of the present invention shown in FIG. 1, there is a third coil 500 that is horizontally aligned with respect to the magnets of the rotating element 20. That is, the axis of coil winding is normal and vertical with respect to the axis of coil windings of coils 310 and 330 which are horizontal. Coil 500, in an exemplary embodiment, is not used to generate an electromagnetic field to rotate the rotating component 20. Just the opposite, coil 500 may be used in an exemplary embodiment to harness the fluxuating magnetic field of the permanent magnets resulting from the passage of permanent magnets 120 through 160 past coil 500 thus generating a current from the coils 500. In an exemplary embodiment of the present invention, the coil 500 is utilized to power another component not shown in the figures.

Alternatively, in addition to powering another component, the coil 500 can be used to power the coils 310 and 330. That is, the current generated from coil 500 can be harnessed to energize coils 310 and 330, thus improving the efficiency of the motor 10. By way of example only and not by way of limitation, the current energized by coil 500 can be sent to a capacitor. The capacitor could accumulate and store the current from coil 500 until a time when some or all of the current can be discharged to either or both of the coils 310 and 330, thus assisting in energizing the coils, which, as noted above, is then used to create a magnetic field to rotate the rotating component 20. Further by way of example, coils 500 could be used to charge a rechargeable battery, from which the coils 310 and 330 can draw current to create the electromagnetic field to drive the permanent magnets. Still further, the horizontal coil could be directly connected to the coils 310 and 330.

Some embodiments of the present invention will utilize more than one horizontally aligned coil 500. For example, 2, 3, 4, 5, 6, 7, 8, 9, and 10 horizontally aligned coils can be utilized with the present invention. Indeed, even more coils can be utilized. It is believed that an almost unlimited number of coils could be used, depending on the design of the embodiment. Thus, any number of horizontal coils can be used to practice the present invention, providing, of course, that the horizontal coils can generate a current from the rotation of the permanent magnets. Further, while coil 500 is positioned horizontally in an exemplary embodiment of the present invention, coils that are aligned differently, such as coils that are aligned vertically and/or are canted from those shown in FIG. 1 can be utilized to practice the invention. Basically, any coil alignment will be suitable to practice the present invention, provided the coils can generate a sufficient current resulting from the passage of the permanent magnets past the coil.

Some embodiments of the present invention operate by alternately energizing and de-energizing coils. During energization, the energized coils impart a force onto the magnets of the rotor to rotate the rotor, during deenergization, the rotation of the magnets is used to induce a current into the de-energized coils. In other embodiments, some coils are always energized while others are never energized, the latter used to harness the current induced by the rotating magnets.

In the first preferred embodiment shown in FIG. 1, the rotating component 20 is configured to rotate in a horizontal plane. However, it is noted that the present invention can be practiced with a configuration where the plane of rotation of the rotating component 20 is a vertical plane. Alternatively, a plane that has both horizontal and vertical components can be used to practice the present invention. Further, the present invention can be practiced where the orientation of the plane of rotation of the rotating component is variable.

The rotating component 20 is supported by bearings (not shown). In the first embodiment of the present invention, these bearings are ball bearings. In another embodiment of the present invention, these bearings are magnetic bearings. Still further the present invention can be practiced utilizing air bearings as well. Basically, any type of bearing that would permit the rotating component to rotate as frictionlessly as possible can be used to practice the present invention.

It is noted, of course, in the case where the rotating component 20 rotates in a vertical plane, the coils 310 and 330 would be aligned or about aligned with that rotating plane as well. It is envisioned that other embodiments of the present invention will exist where the plane of rotation of the rotating component lies on a different plane then that of the coils 310 and 330. In one embodiment of the invention, the plane of the driver coils 310 and 330 is slightly below the plane of rotation of the rotating component. In this embodiment, the horizontal coil could be on the same plane as the driver coils, or on the plane of the rotating coil, or on another plane, or, in the case of a plurality of coils, could be on a variety of planes.

It is noted that in describing the various embodiments of this document, references to a particular component or a plurality of components are used to describe another component, such as the spatial positioning of another component. Other reference configurations that could readily be ascertainable or are inherent in the description are part of the present disclosure, although perhaps not explicitly described, and could be used to describe the present invention.

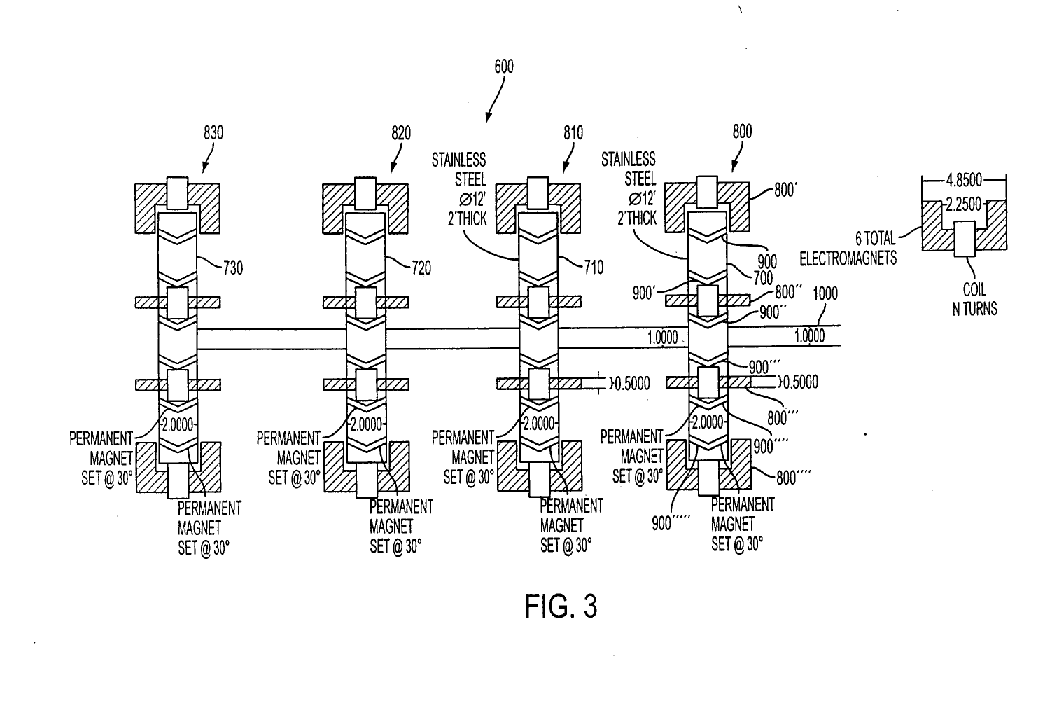

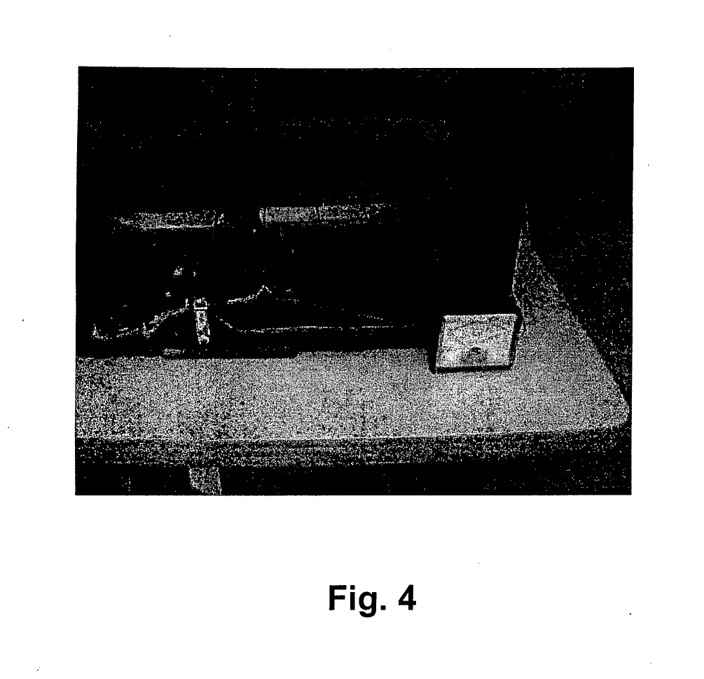

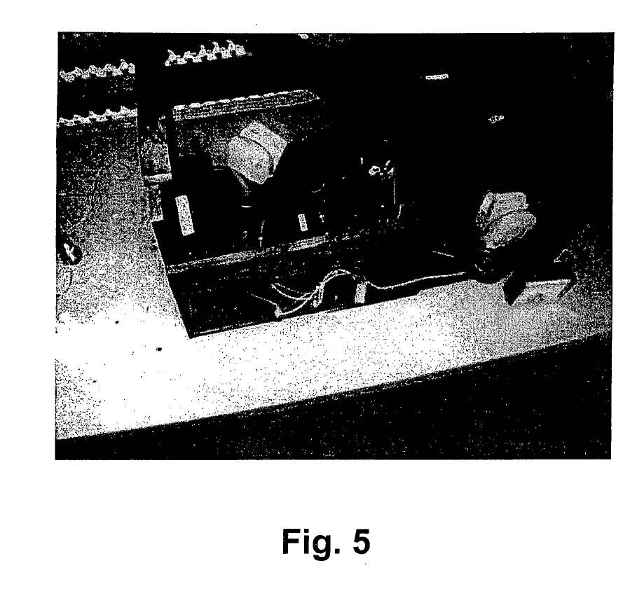

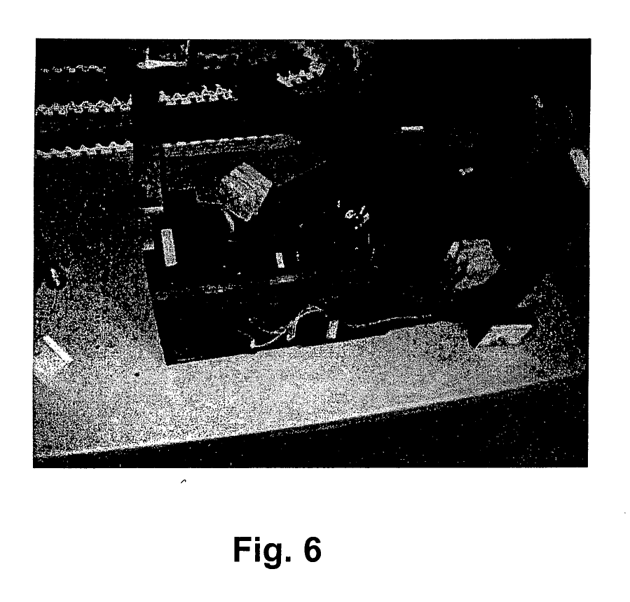

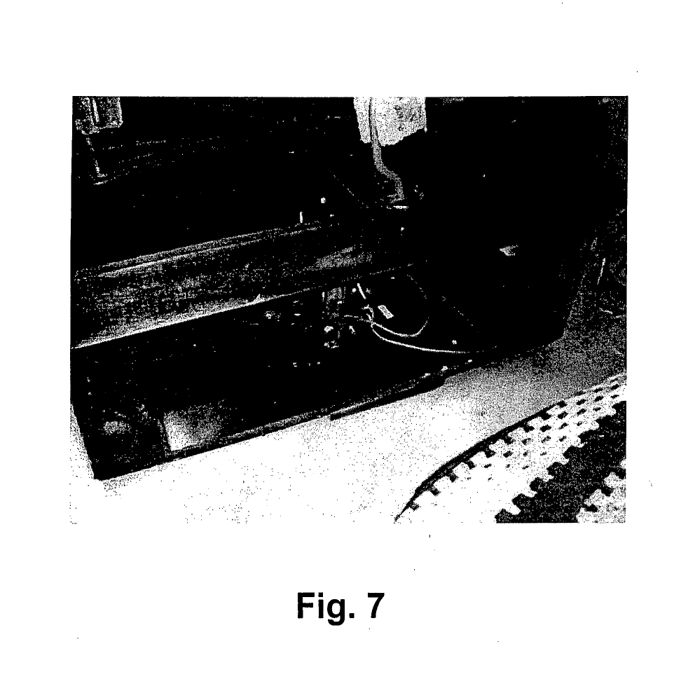

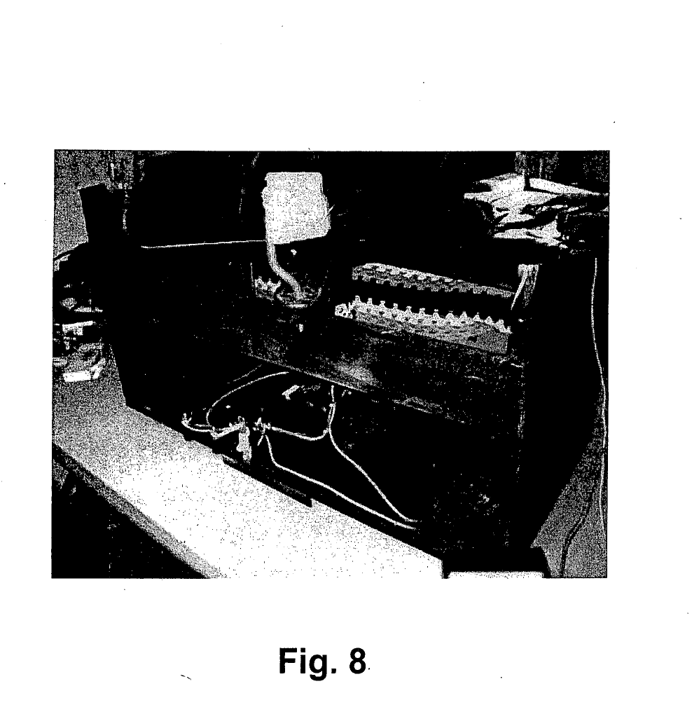

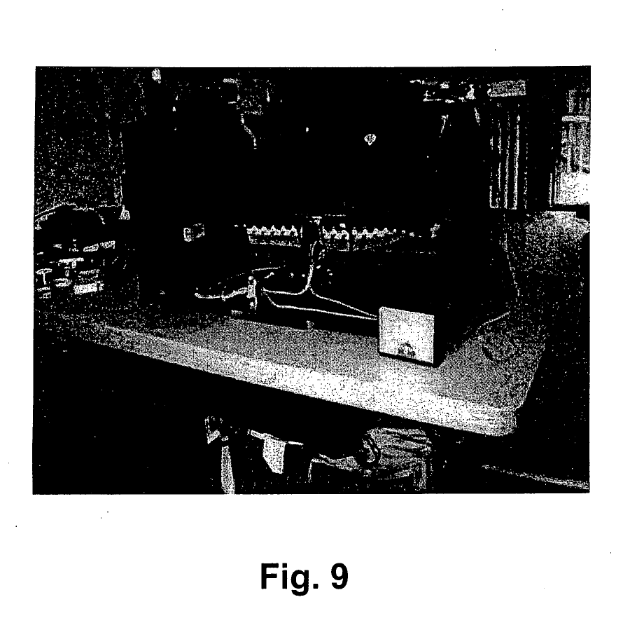

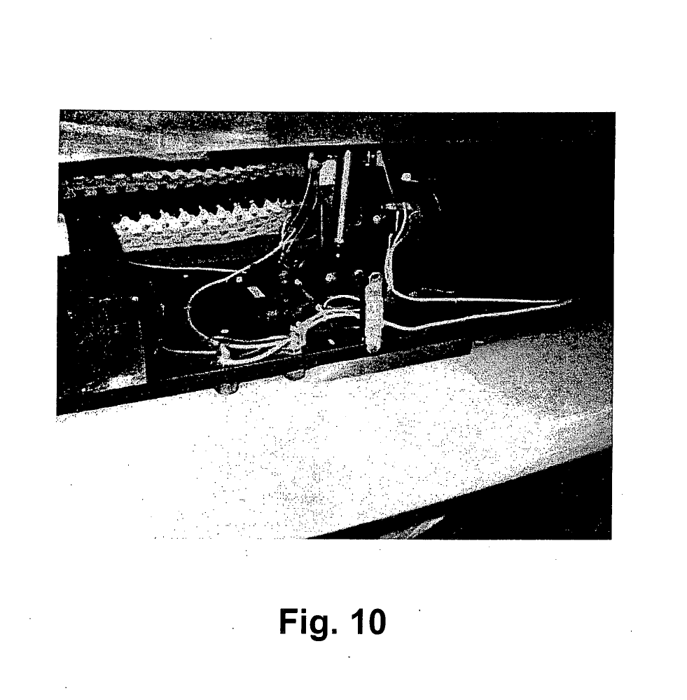

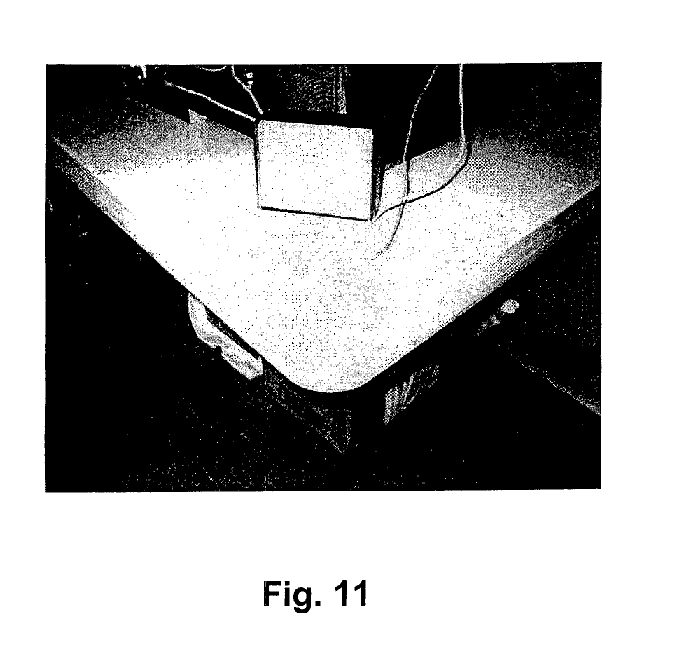

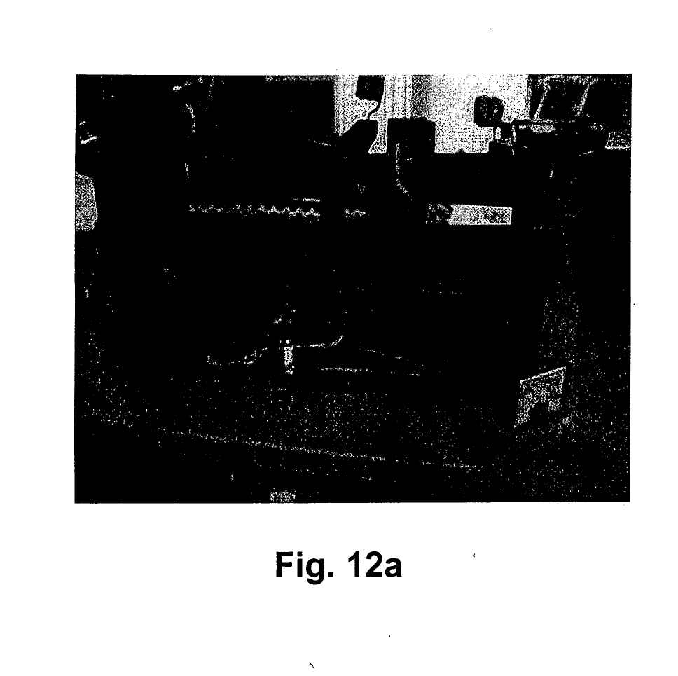

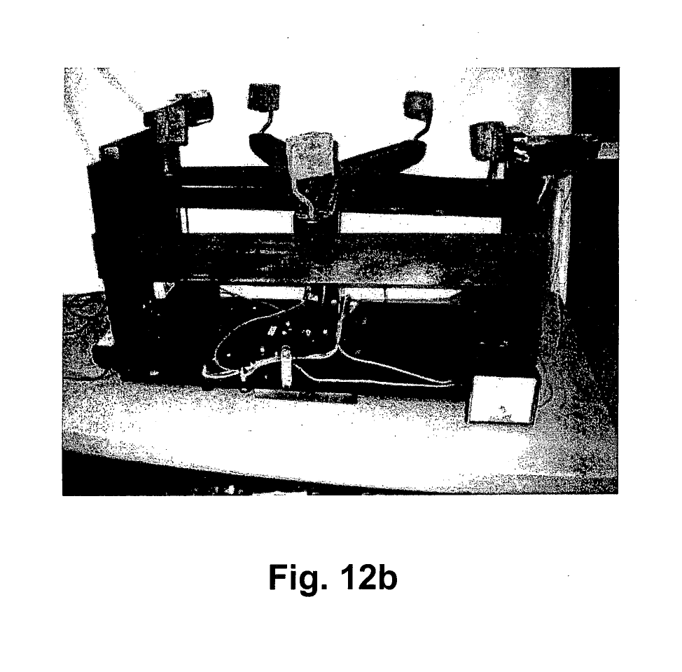

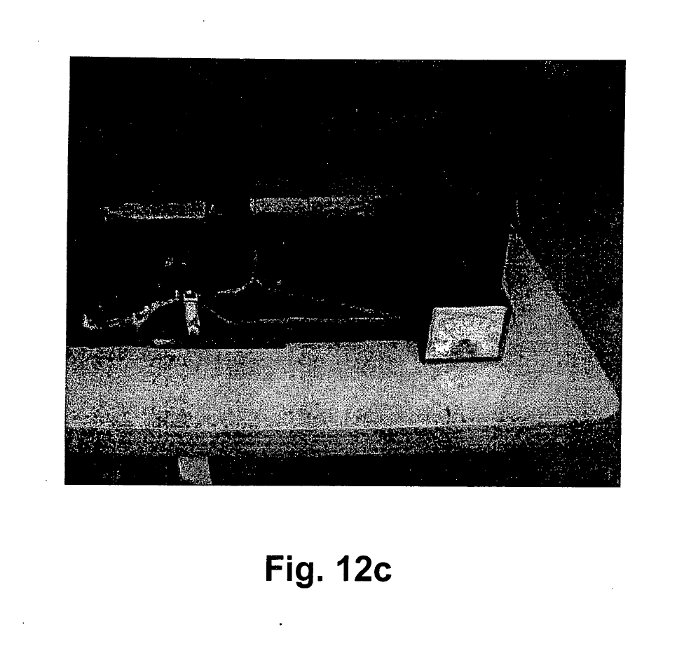

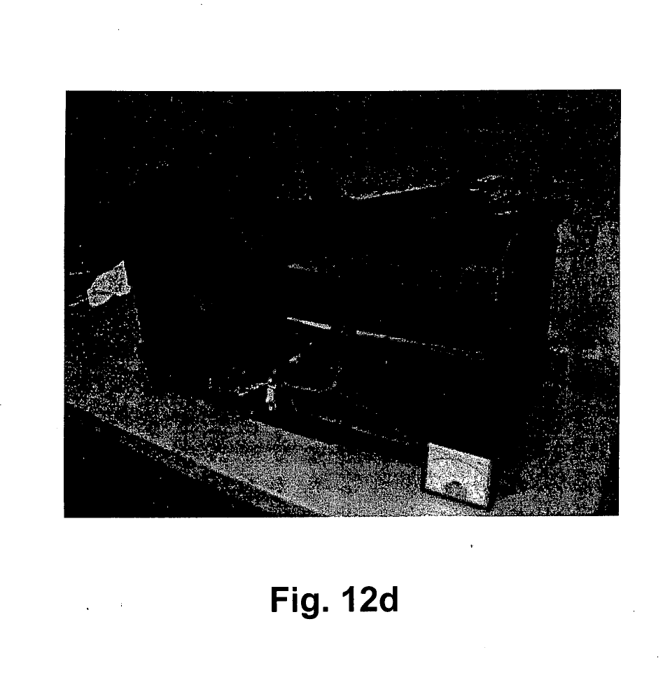

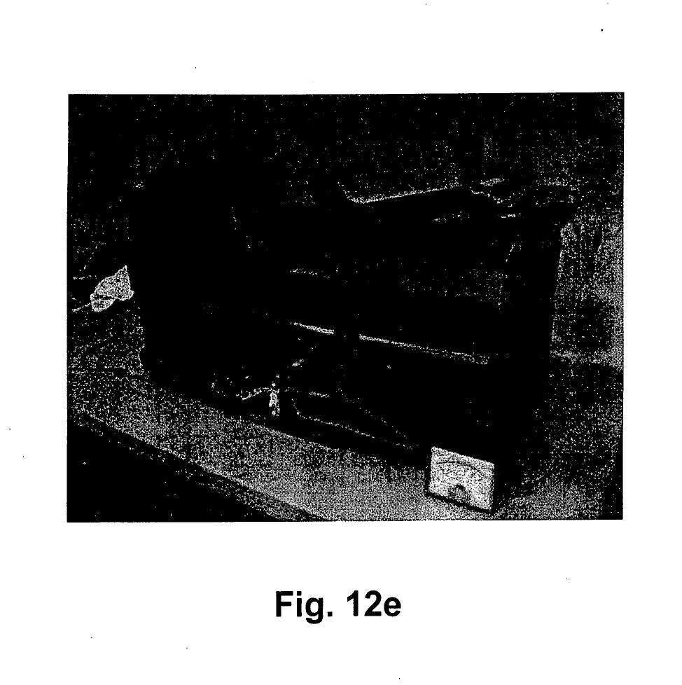

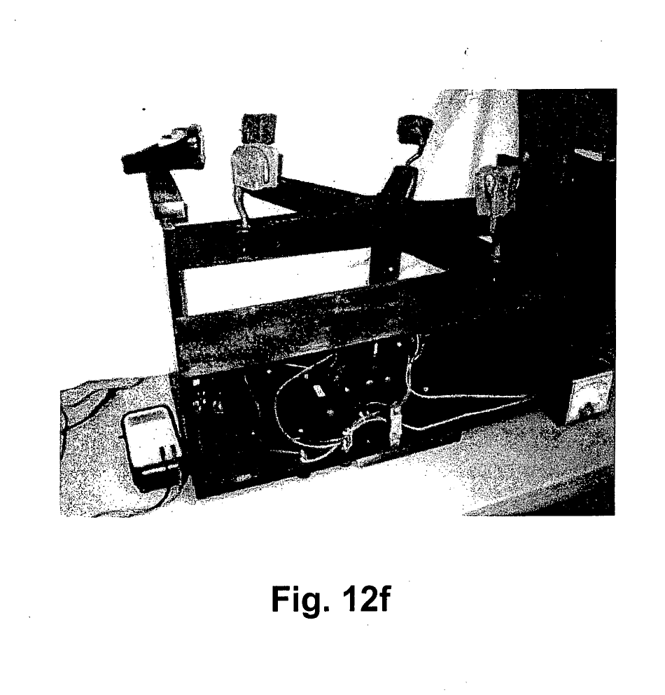

Another embodiment of the present invention is shown in FIG. 3. It is possible that by timing the current through the coils of the embodiment of FIG. 3 (in a similar manner or in the same manner as the embodiment of FIG. 1), constant circular motion of the rotating component is achieved. When the rotating component reaches a desired RPM, the coils can be deactivated one at a time or in a pattern and still will maintain a constant RPM. As load is applied to the motor, RPM will drop in proportion to the load applied. After the RPMs drop (or before in anticipation of the RPM drop), some or all of the deactivated coils can be activated one at a time or in a pattern to raise the RPM. This can be controlled electronically or by a computer.

As the permanent magnets pass the deactivated coils, the magnets induce a voltage into the coils that can be returned to the battery used to fire the coils, thus achieving a self-sustaining effect. It is noted that this principal of operation is similar to that of at least some of the embodiments described above, and is the same as that of at least some of the embodiments described above.

In the embodiment of FIG. 3, motor 600 includes a series of coil sets 800, 810, 820 and 830 surrounding, respectively, a series of rotating disks 700, 710, 720 and 730 which are the equivalent to the rotating component 20 of the embodiment of FIG. 1. In the embodiment shown in FIG. 3, rotating components 700 through 730 are stainless steel disks having a thickness of 2 inches. The coil sets may include 6 coils. FIG. 3 shows coil 800′, 800″ 800′″ and 800″″. It is noted that 2 coils are not shown for clarity.

In the embodiment shown in FIG. 3, the 6 coils of coils set 800 are positioned about the axis of the disks 700 through 730. The coils may be radially spaced about the disks 700 through 730 so that the coils are equidistant from each other. That is, the coils are spaced about 60° from each other along the circumference of the disks 700 through 730. In the embodiment shown in FIG. 3, the disks 700 through 730 are axially aligned with each other and are connected by shaft 1000. The coils of the coil sets are likewise axial aligned and coupled with each other. Thus, when one rotating component rotates, for example, component 700, disks 710 through 730 rotate as well. Located in each disk are permanent magnets. A representative configuration of the permanent magnets of the disks of this embodiment is shown at disk 700, which contains magnets 900, 900′, 900″, 900′″, 900″″ and 900′″″. In this embodiment, the permanent magnets may be evenly spaced throughout disks 700 through 730. In the embodiment of FIG. 3, the permanent magnets are in a set where the sets are angled at 30° from the center of rotation of the disks, the sets having a “V” shape, as shown in FIG. 3, where the angle between the arms of the “V” is about 120 degrees. Other embodiments of the invention can be used where the angle is greater than or less than 120 degrees. The disks 700 through 730 are preferably 18 inches in diameter and 2 inches in thickness and are made from solid stainless steel. However, other embodiments of this configuration can be practiced utilizing disks of smaller dimension or of larger dimension, or of different material.

In the embodiment shown in FIG. 3, each coil set can be energized at the same time or in a staggered pattern. Furthermore, the individual coils of each individual coil set can be energized in a staggered fashion as well. The staggering of the individual coils coincides with the staggering of the energizing of the coil sets. One method of utilizing the apparatus of the embodiment shown in FIG. 3 is to energize all of the coils at one time (or have all of the coils energized at one time until the disks rotate at a desired RPM). After achieving the desired RPM, some or all of the coils can be de-energized after which only certain coils are again energized to boost the RPM back to the desired RPM. It is believed that RPM drop can result from general friction after the coils are de-energized, as well as from load being applied to the shaft. Thus, the number of coils energized can be variable, depending on the friction and load applied to the shaft.

The coils that are de-energized can be used to harness the magnetic field produced by the rotating magnets of the disks 700 through 730. Thus, a current can be induced through the non-energized coils. The current from the non-energized coils can be utilized in the same or similar manner as the current obtained from the horizontally aligned coil 500 discussed in reference to FIG. 1.

Still further, additional disks and additional coils can be added to the device shown in FIG. 3. These disks and coils can be utilized to rotate the shaft 1000 or can be dedicated to harnessing the magnetic field produced by the rotating magnets. It is noted that while FIG. 3 shows only 4 disks, the configuration of FIG. 3 can be practiced with fewer disks or more disks. By way of example, 1, 2, 3, 4, 5, 6, 7, 8, 9 and 10 disks and accompanying coil sets can be used to practice the invention. Almost an unlimited number of disks and coil sets can be used to practice the invention. Further, the number of coils in each coil set and the number of magnets in each disk can be fewer than 6 or can be more than 6. Basically, any number of disks, magnets, coil sets and coils can be utilized to practice the invention as long as a sufficient magnetic field can be generated and harnessed.

Still further, the present invention can be practiced with configurations and/or dimensions that are different than that shown in FIG. 3.

In this description, the present inventors teach a plurality of embodiments within the present invention. These embodiments are believed by the present inventors to achieve the goals of the present invention, which is to obtain a highly efficient magnetic motor that is driven from a power source to generate power that can be used to power the motor. In a preferred embodiment of the invention, the current that is obtained from the coils by the rotating magnetic field generated by the rotation of permanent magnets by energizing the driver coils (e.g. coils 310 and 330) of the present invention can be returned to the driver coils or a power source, such as a battery, that is used to power the driver coils. The current produced in an exemplary embodiment may be a current that is greater than the current used to rotate the permanent magnets, thus producing a result that is similar to or possibly even the same as a self sustaining result or even resulting in surplus power that can be used to power other devices. The current produced by the motor may be surplus power. Alternatively, in other embodiments of the present invention, the current generated by this power can be used to power another device such as another electric motor, light generating devices, computer devices, military power generators, residential and industrial power generation, vehicle, a residence, an industrial facility, industrial equipment, medical equipment, appliances, cars, small trucks, large trucks, busses, farm equipment, medical support equipment, wheel chairs, aircraft, watercraft, small engines for lawn mowers, snowmobiles. The motor may also serve as a generator unit, such as a back-up generator unit. The motor may serve as a portable generator that may be provided in remote locations or areas that have lost power or are without power.

In some embodiments of the present invention, as seen above, the operation of the magnetic motor is controlled electronically. However, other embodiments of the present invention can be controlled mechanically, or put through a combination of electrical and mechanical control equipment.

Further still, the present invention can be practice utilizing a dedicated computer specifically designed and programmed to control the operation of the motor.

In another embodiment of the present invention, current is obtained from the driver coils 310 and/or 330 via a hysteresis effect resulting from energizing of the coils. In theory, current can be obtained from the coils that are energized because the coils remain charged and/or partially charged, for a brief period after the current is removed from the coils. This period is believed to be about 2 to 3 milliseconds, but can be more or less in other embodiments of the invention.

In another embodiment of the present invention, the motor includes a rotating disc or rotor that includes areas for holding magnets and an axis of rotation. For example the rotating disc may include apertures, notches, or pockets for containing magnets on a periphery of the rotating disc or on ends of a rotor, such as at the ends of rotor armatures. While a rotating disc may be used, other members of varying geometry and size may be used that are suitable for moving magnets past coils. For example, the rotating disc may be a rotating polygon, such as a hexagon or octagon, or the rotating disc may be a member with spokes, or other rotating device known in the art.

The motor may include an external power source to initiate movement of the rotating disc. For example, the motor may include a battery to initially energize the coils and accelerate the rotating disc. Energized coils create fields that interact with the magnets mounted in the rotating disc, causing the rotating disc to rotate on its axis. The rotating disc may be accelerated by energized coils to a predetermined operating speed. Once the rotating disc has reached a predetermined operating speed, the operating speed may be maintained by coils that are periodically energized. Coils that are not energized may functions as pick-up coils or inductance coils that have a current induced by the spinning magnets on the rotating disc. The motor may have a single set of coils that function as energizing or firing coils and as pick-up or inductance coils, or the motor have separate sets of energizing coils and inductance coils. Current produced in the inductance coils may then be used to power the energizing coils. In this way, the external power source may be disconnected from the motor and predetermined operating speed of the motor may be maintained by inductance coils, so that the inductance coils solely provide the power for the energizing coils. The motor may include a wire harness to distribute the induced current to a control system for the motor.

A control system for the motor may include a transformer for controlling the voltage of the power produced by the motor. The control system may be designed to control the energizing coils so that coils are energized when the spinning magnets are in proximity to the coils. Energizing coils may be fired periodically to maintain a predetermined operating speed of the motor, allowing the motor to use little energy and operate in an efficient manner. The motor may be designed so that the rotating disc spins with extremely low resistance. For example, the rotating disc may include low-friction bearings to support the rotating disc so that little energy is needed to accelerate the rotating disc and maintain the rotating disc at a predetermined operating speed. The control system may further include an operating panel with controls and outlets for providing various sources of voltage, amperage, and power phases. For example, 120 volts or 280 volts and/or single- or three-phase power may be supplied, along with other forms of power known in the art.

It is believed that the current that remains in the coils after the coils are disconnected from the power source (de-energized) can be can be harnessed. By way of example, the current can be used to charge a capacitor. Over a period of time, the capacitor will build up a charge that can be utilized. For example, the capacitor could be used to power another electric device, or used to energize the coils 310 and/or 330.

In an experimental version of the present invention a 12 volt DC battery was connected to a device as seen in FIGS. 1 and 2. Magnetic motor 10 was powered and brought up to speed. The magnetic field created by the rotation of the permanent magnets was utilized to produce current at horizontal coil 500. A volt meter attached to the horizontal coil recorded that between 8 and 12 volts were present at the coil. It is believed that the current obtained from the horizontal coil 500 of the experimental can be harnessed to energize the coils 310 and 330 that drive the rotating component 20, thus, producing a self-sustaining or quasi-self sustaining effect. That is, it is believed that the 12 volt battery 400 could be disconnected from the system and the rotating component 20 would continue to rotate for a very long period of time, a time period believed to be approximately as long as the period where the efficient magnetic motor 10 would fail due to mechanical fatigue (wear, etc.).

In another working example, a wheel was constructed from a solid mild steel wheel. A steel cup was constructed from a ⅛″ stainless steel plate. Neodymium permanent magnets with a size of 2×2×½″ at 35 G were provided. A coil mount plate was made from a ¼″ nylon plate. Energizing coils were constructed from 200 wraps of magnetic wire at 16 Ga. The motor base was constructed from aluminum plates to form ¼″ thick side plates and a ½″ thick back plate. A shaft was made from a 16″ long shaft with a 1″ OD. Inductance coils were made from 7000 wraps of magnetic wire at 24 Ga. A circuit board was provided for mounting electrical relays of various sizes for input and output of electrical energy. A front cross brace was constructed from a ¼″ thick aluminum plate. A sealed pillar block bearing with a 1″ ID was provided to serve as the bearing for the shaft.

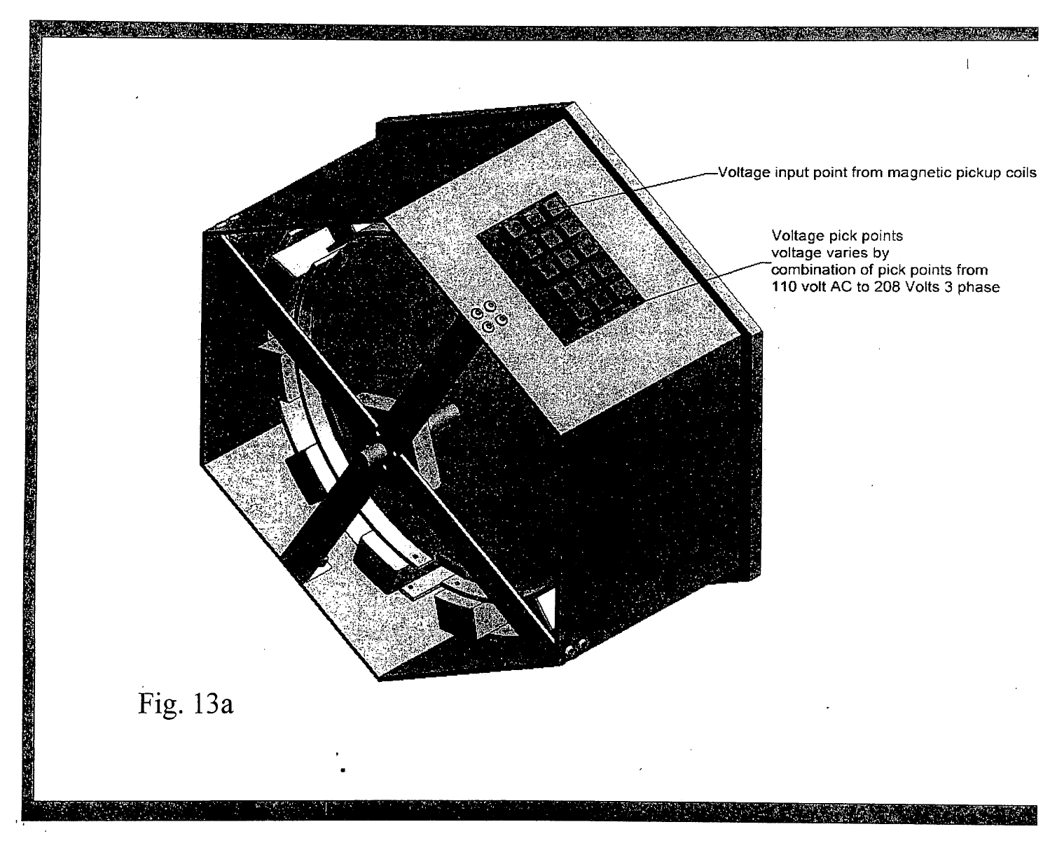

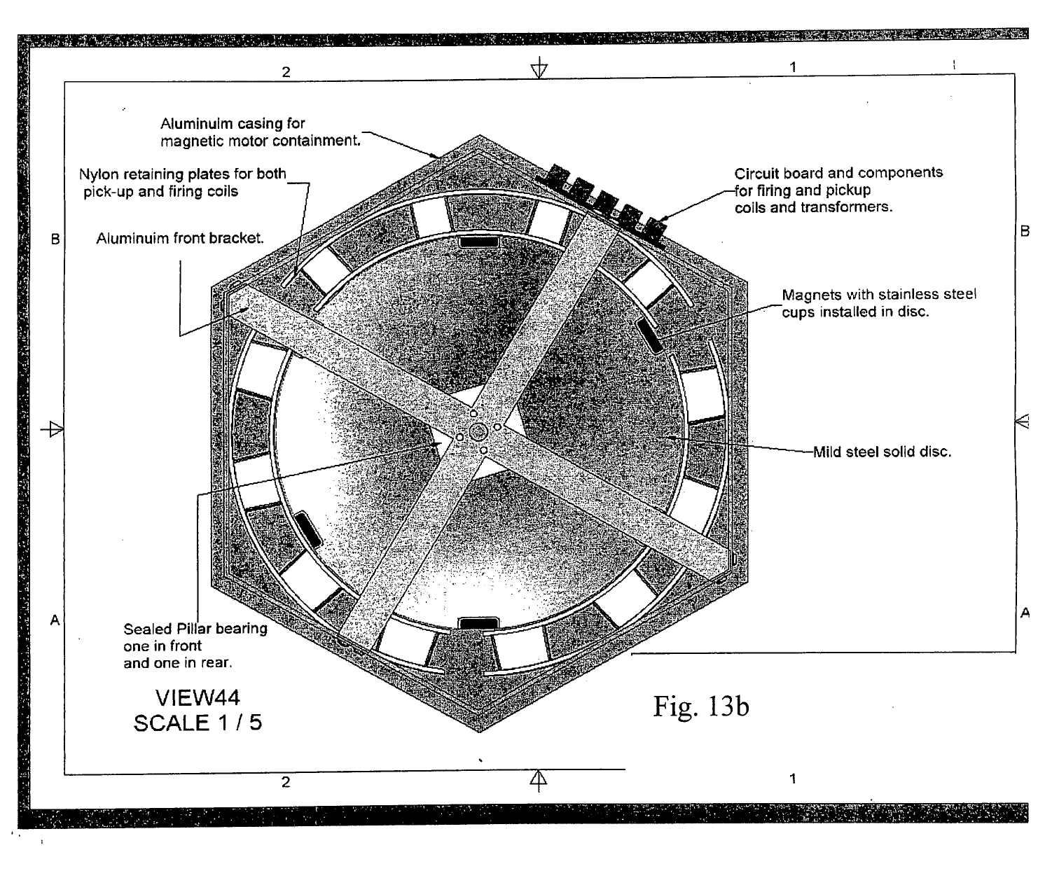

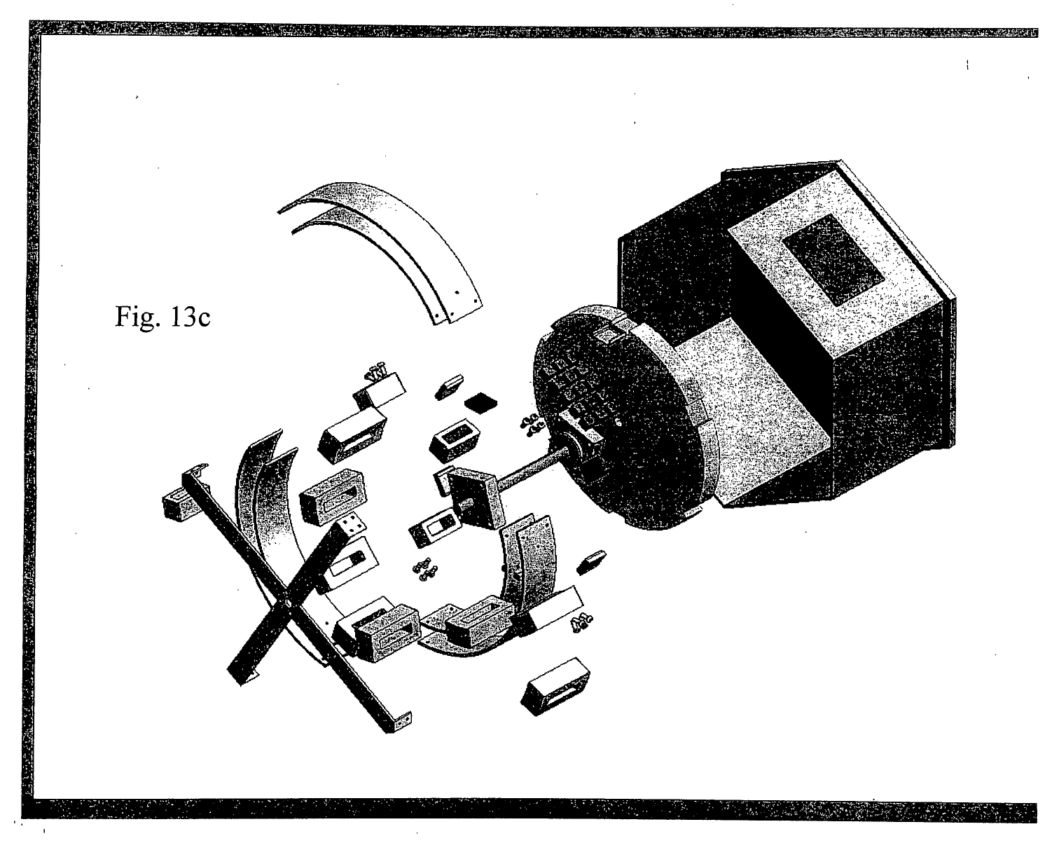

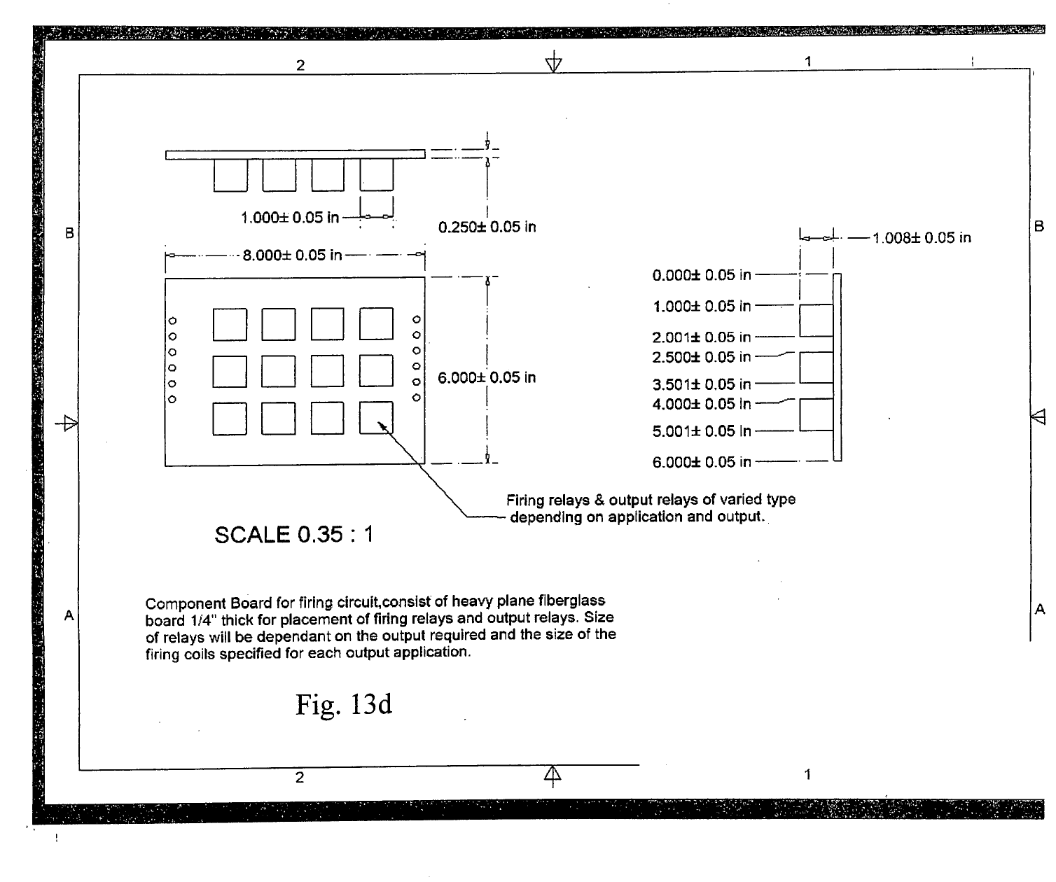

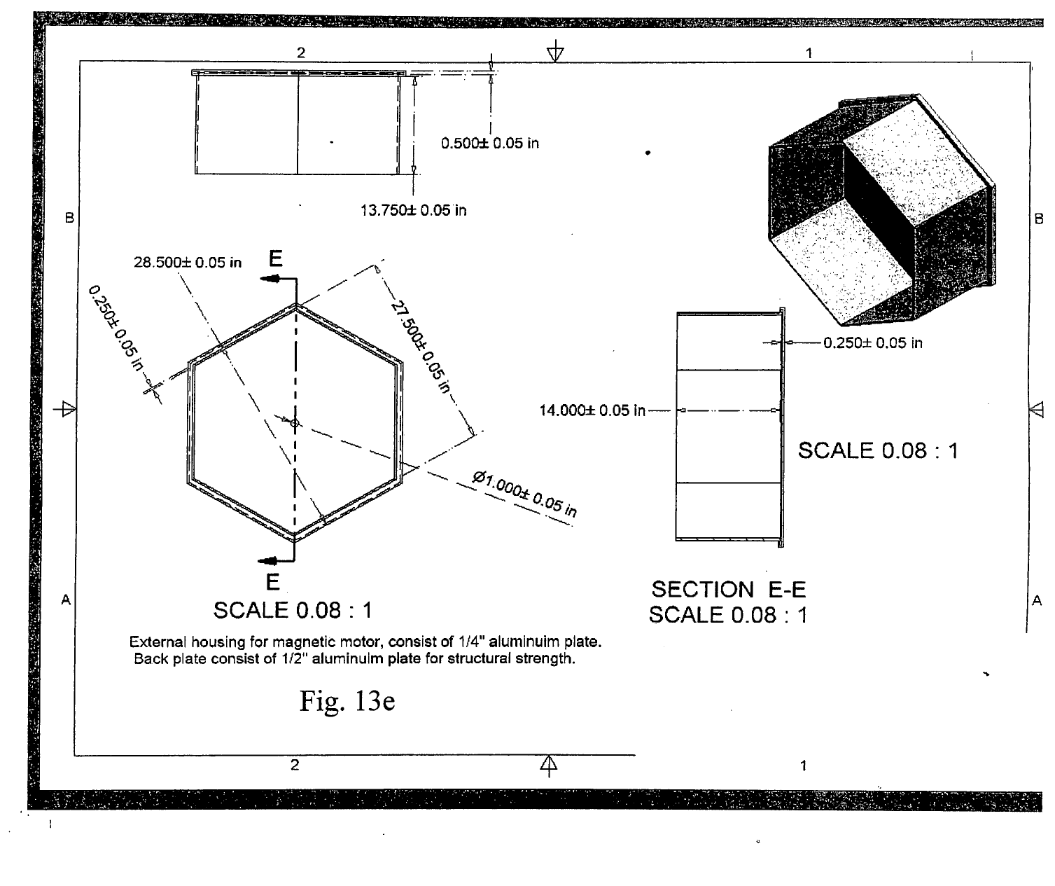

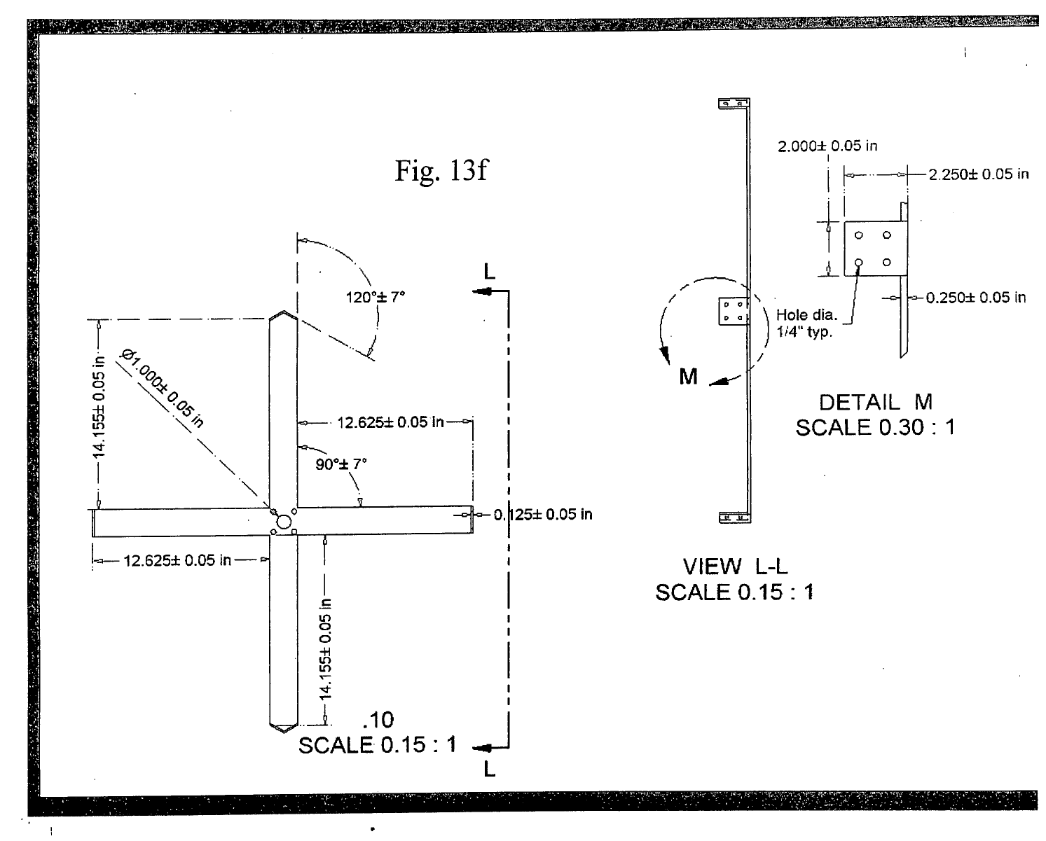

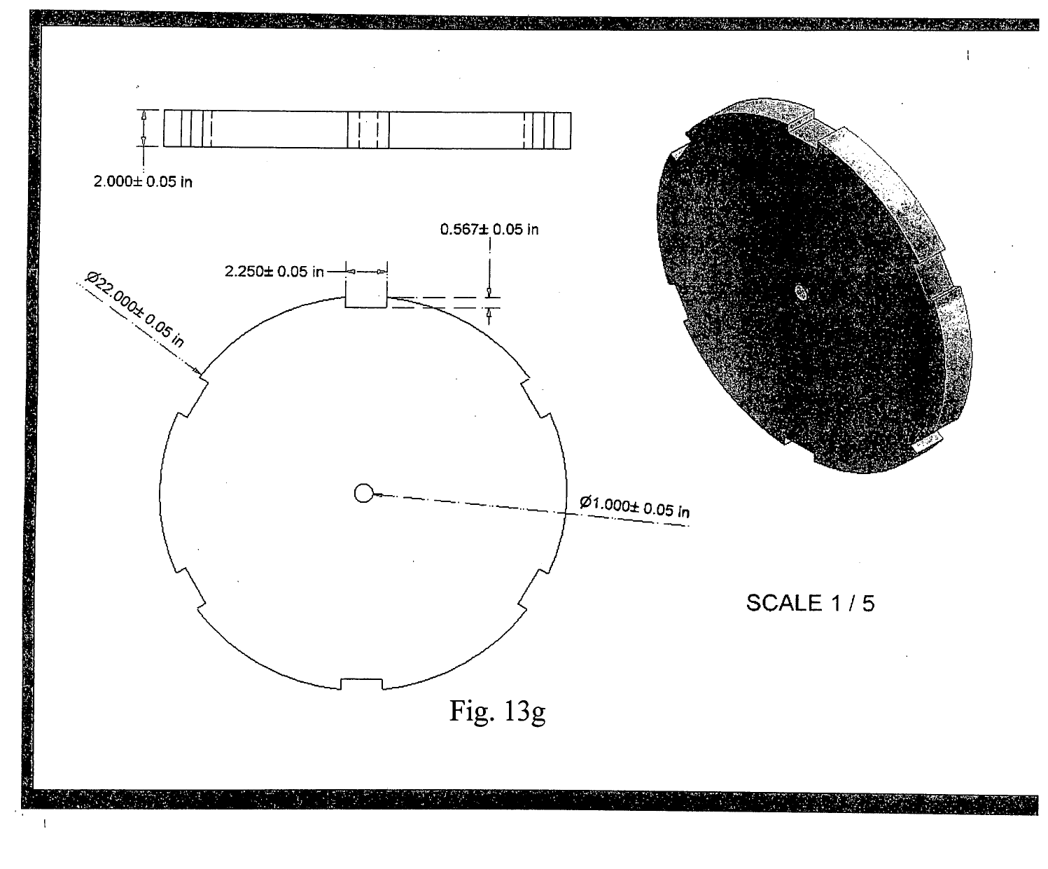

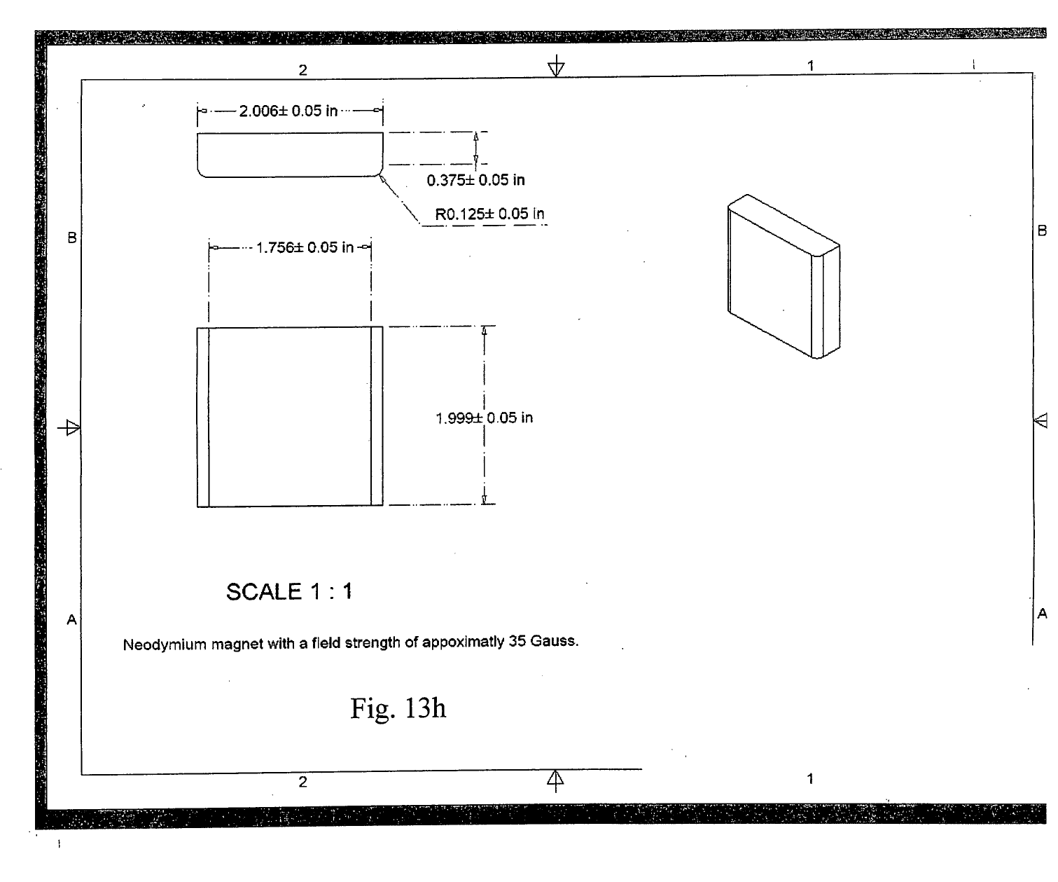

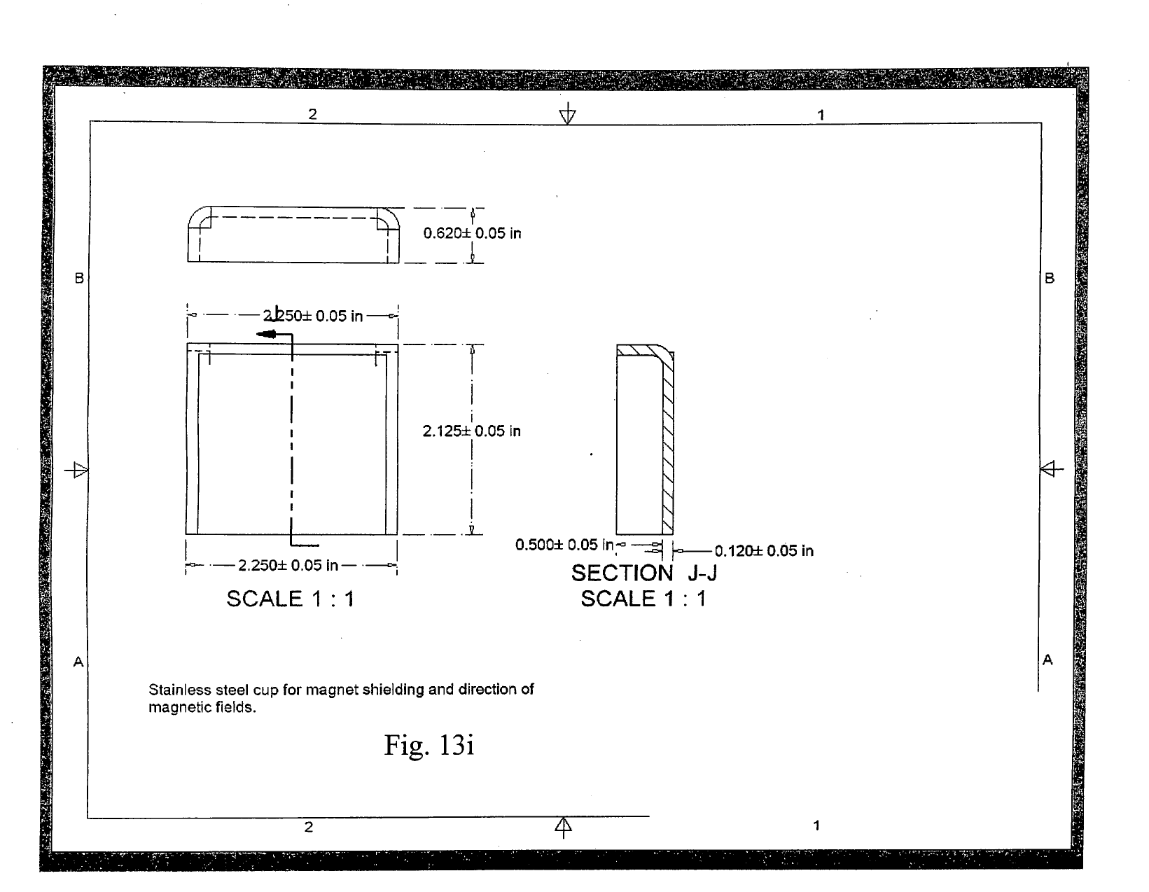

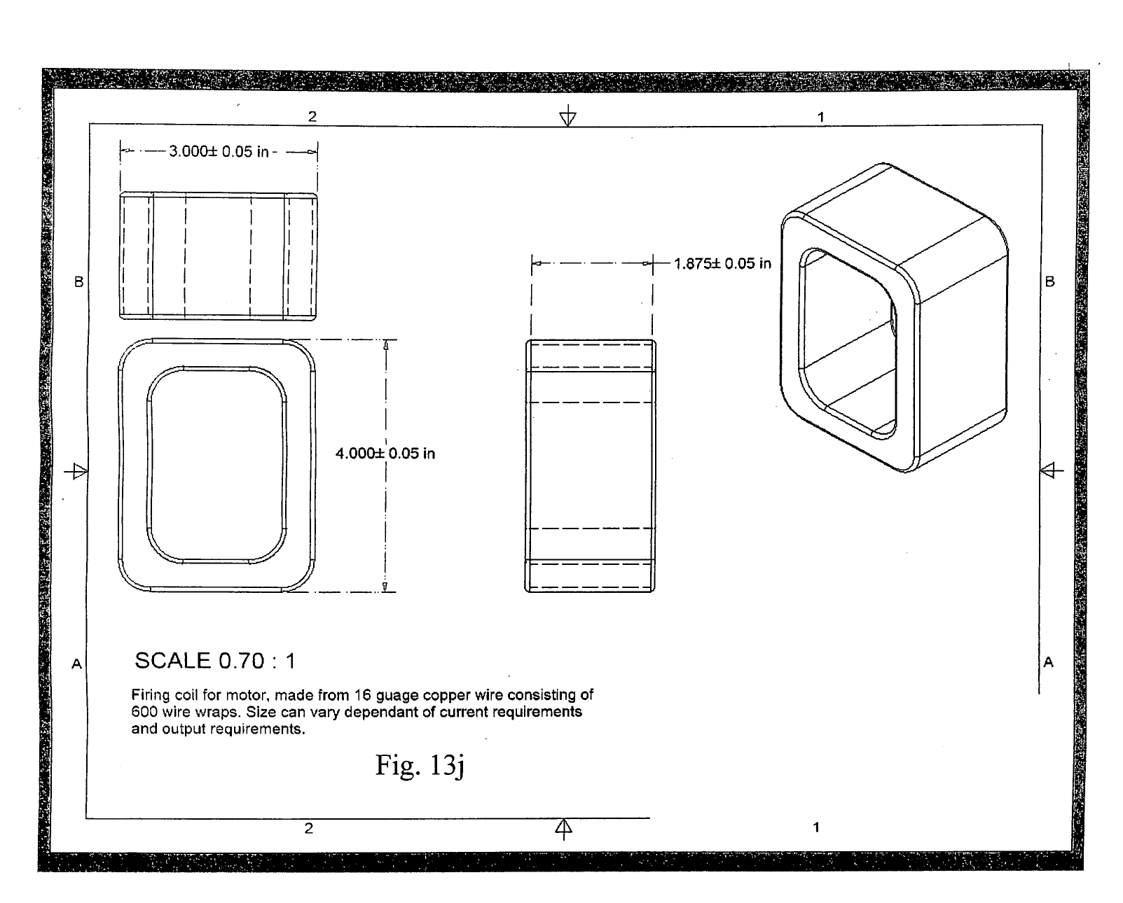

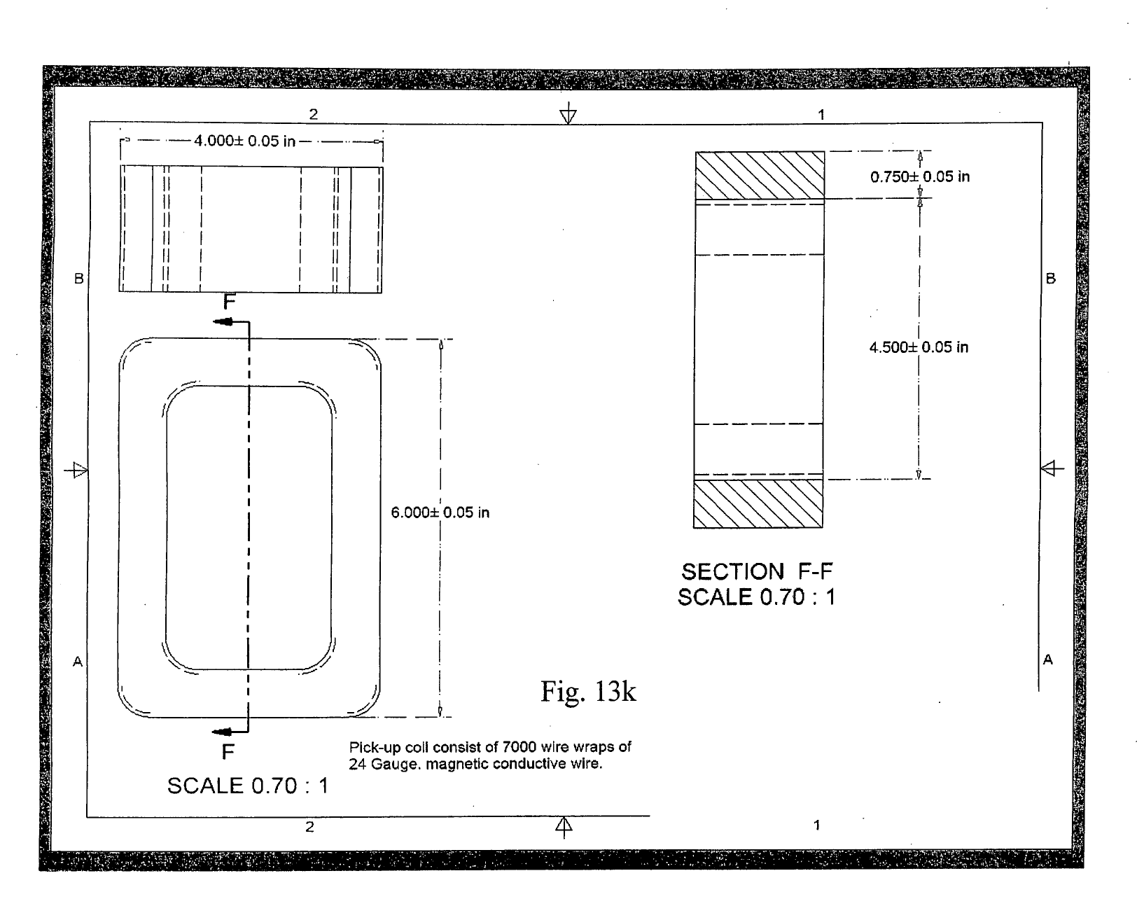

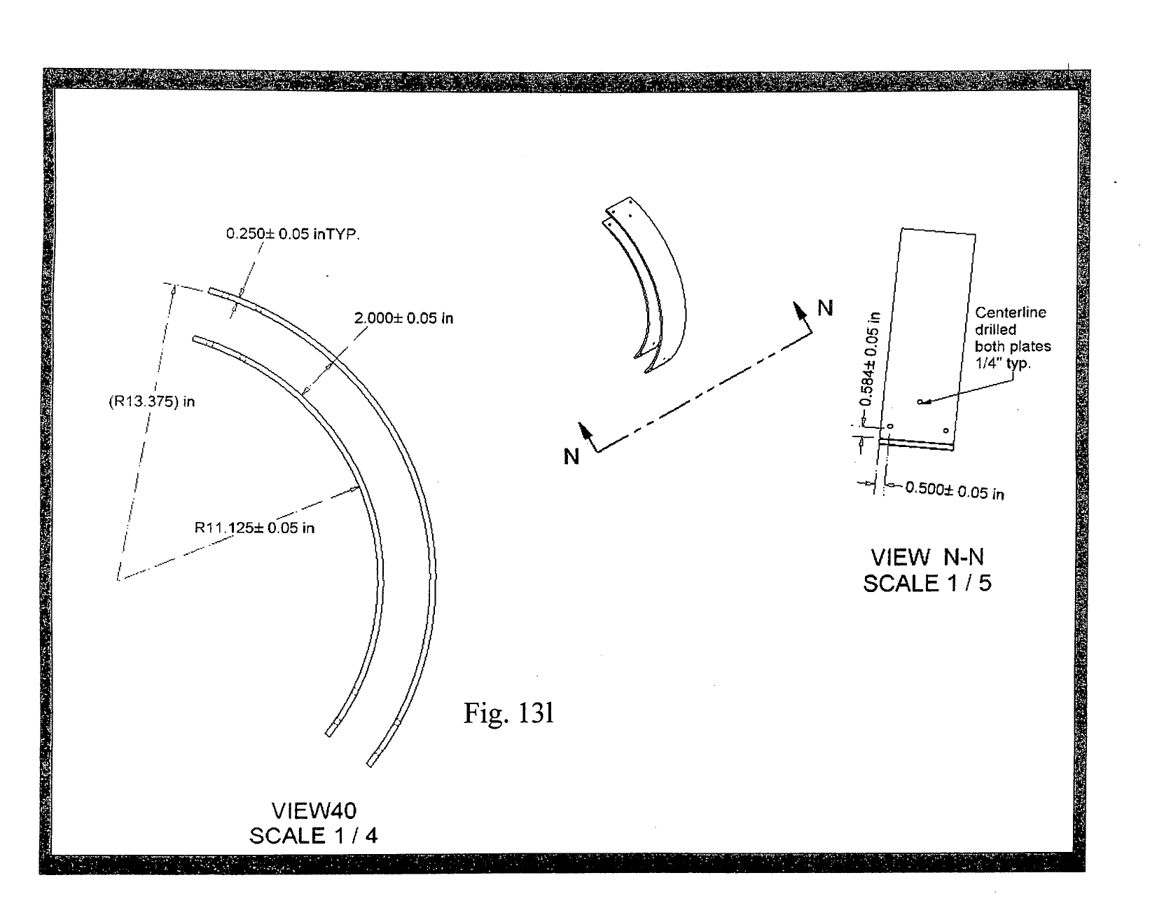

FIGS. 13a-13l provide views of a working example of a magnetic motor according to an embodiment. FIGS. 13a-13l provide exemplary structures, geometries, dimensions, and materials for constructing an example of the motor. The structures, geometries, dimensions, and materials are not to be considered as limitations of the present invention, but to serve as examples to demonstrate how one of ordinary skill in the art may reproduce an example of the motor.

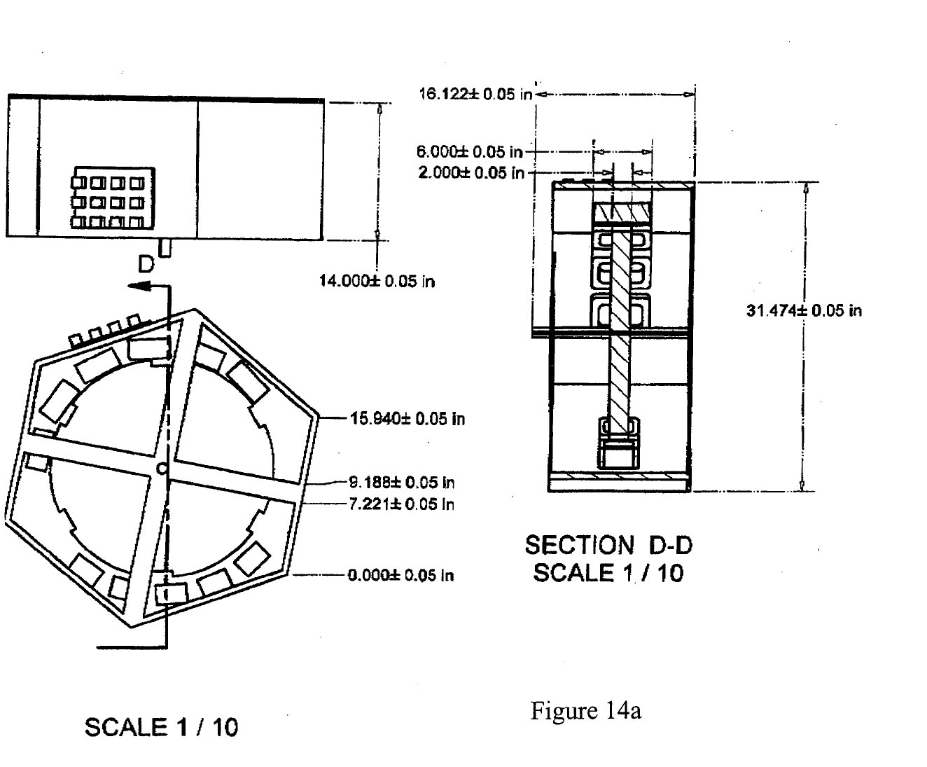

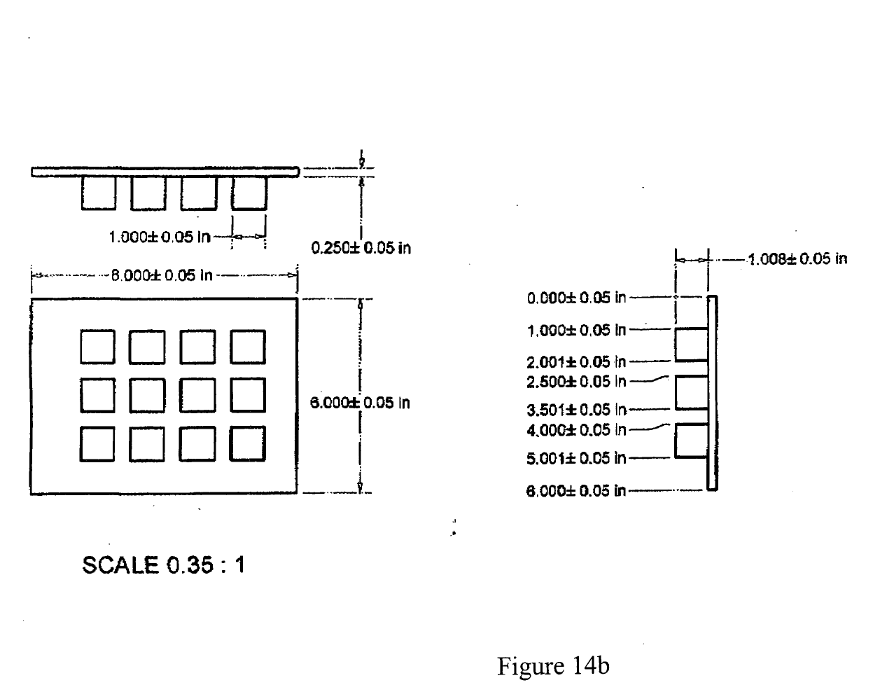

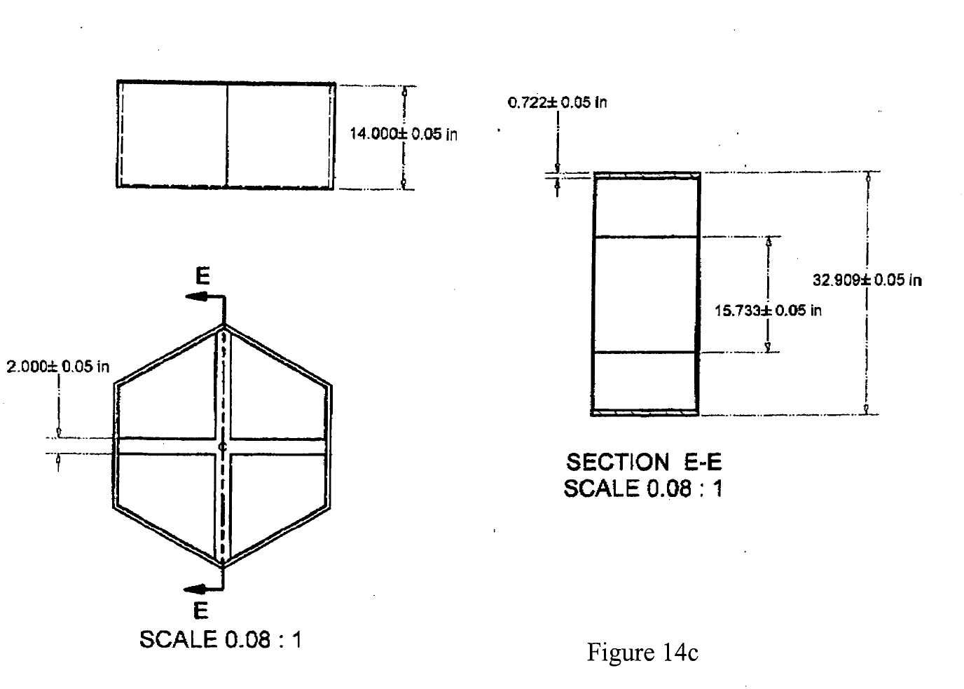

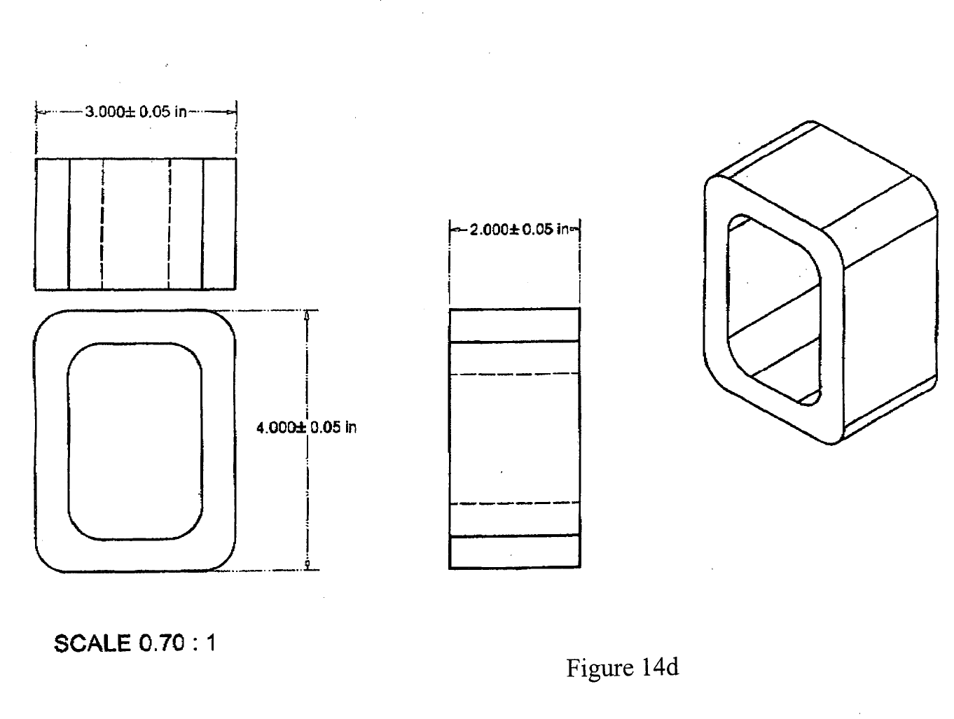

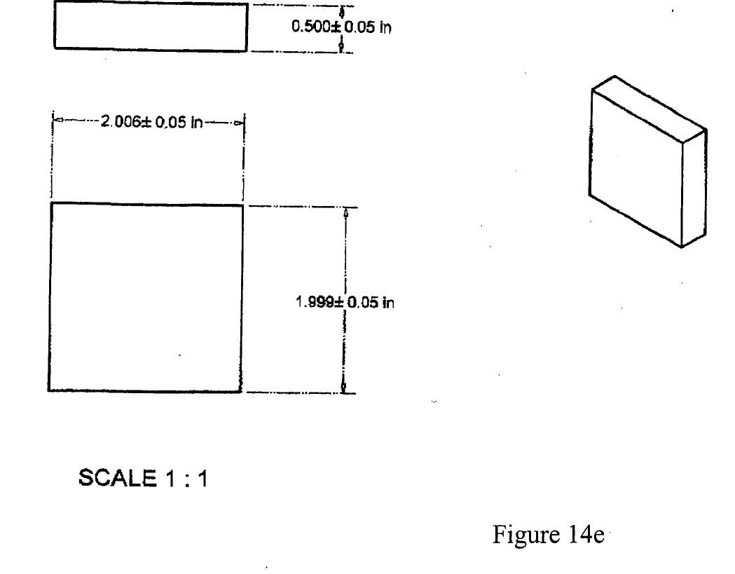

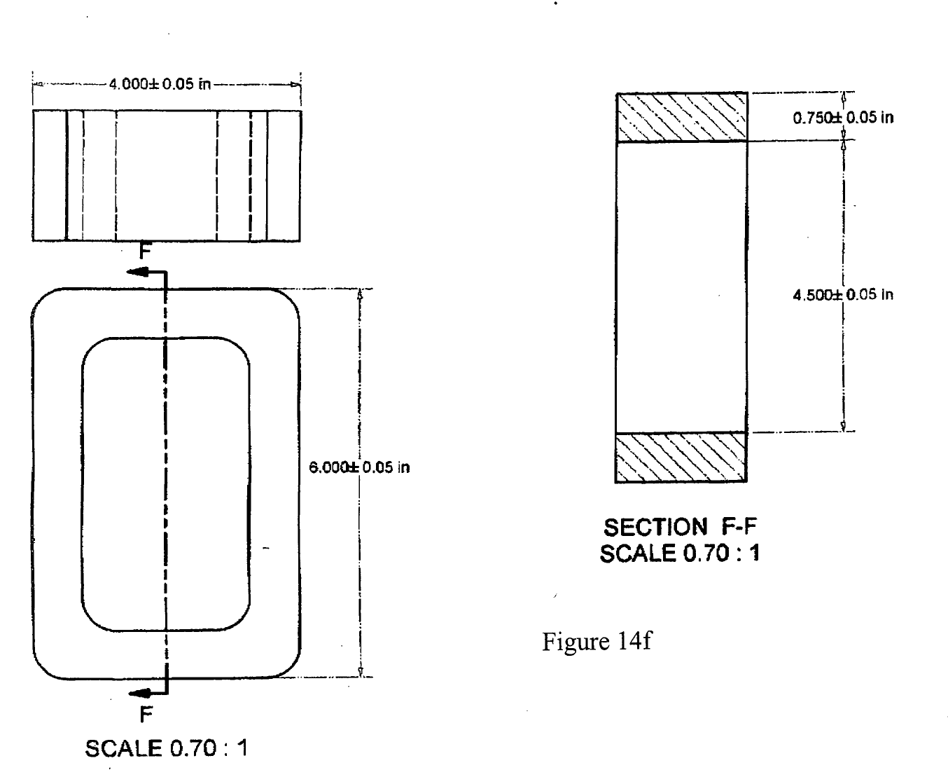

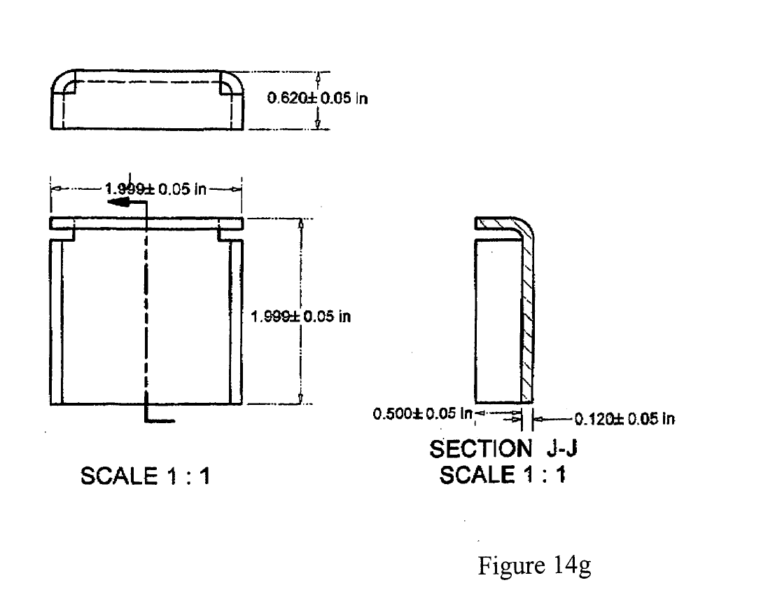

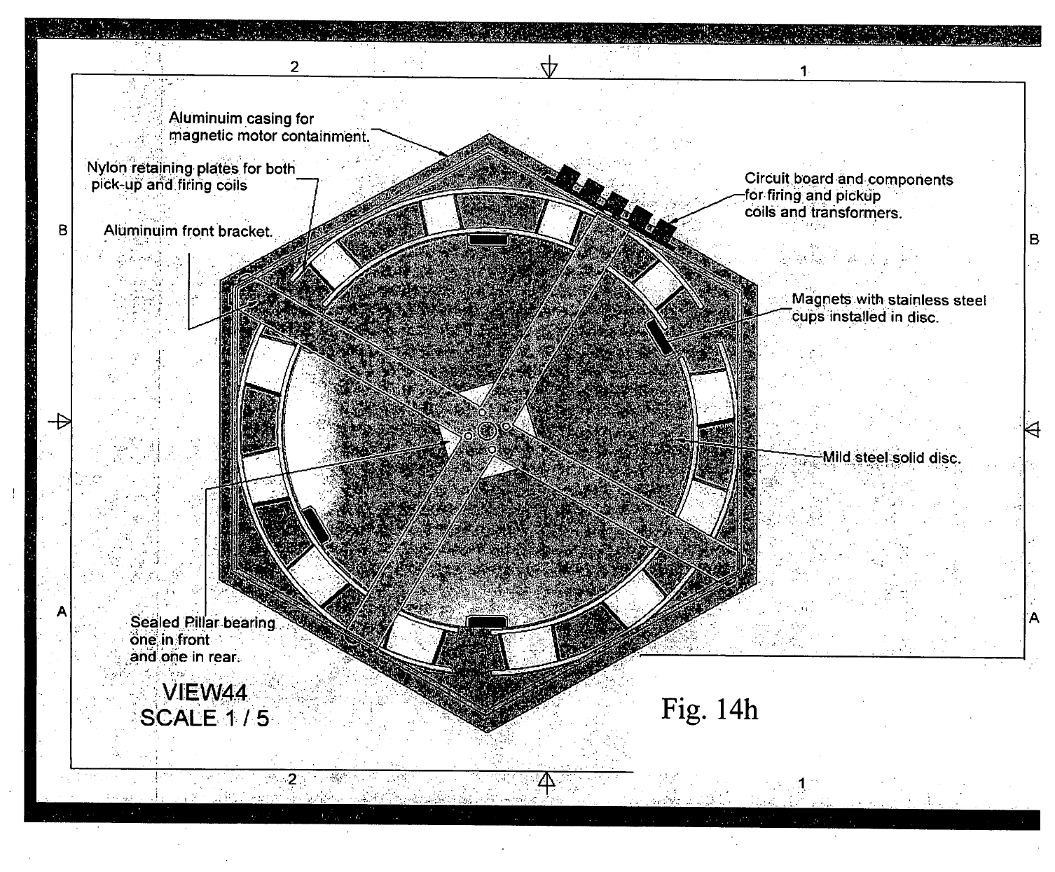

FIGS. 14a-14h provide views of another working example of a magnetic motor according to an embodiment. FIGS. 14a-14h provide exemplary structures, geometries, dimensions, and materials for constructing an example of the motor. The structures, geometries, dimensions, and materials are not to be considered as limitations of the present invention, but to serve as examples to demonstrate how one of ordinary skill in the art may reproduce an example of the motor.

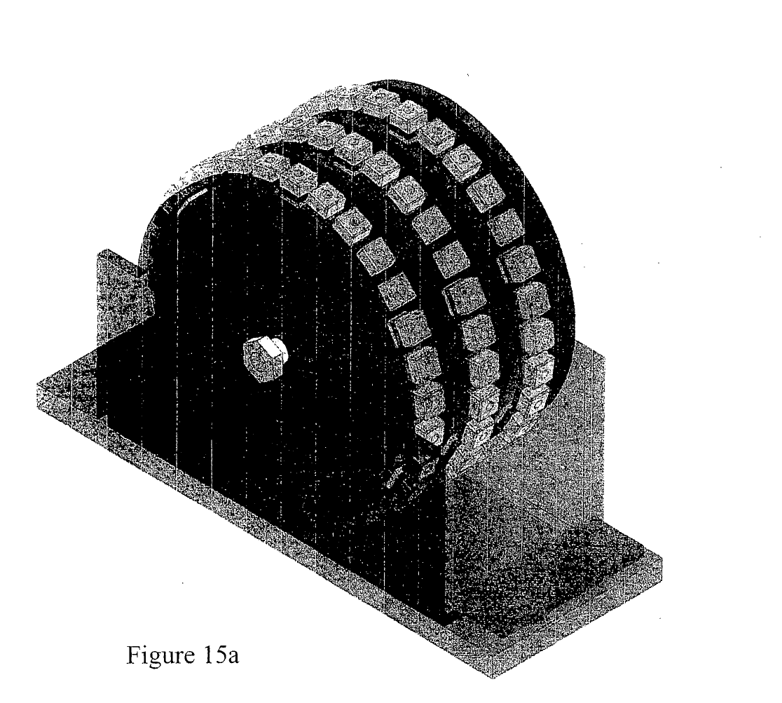

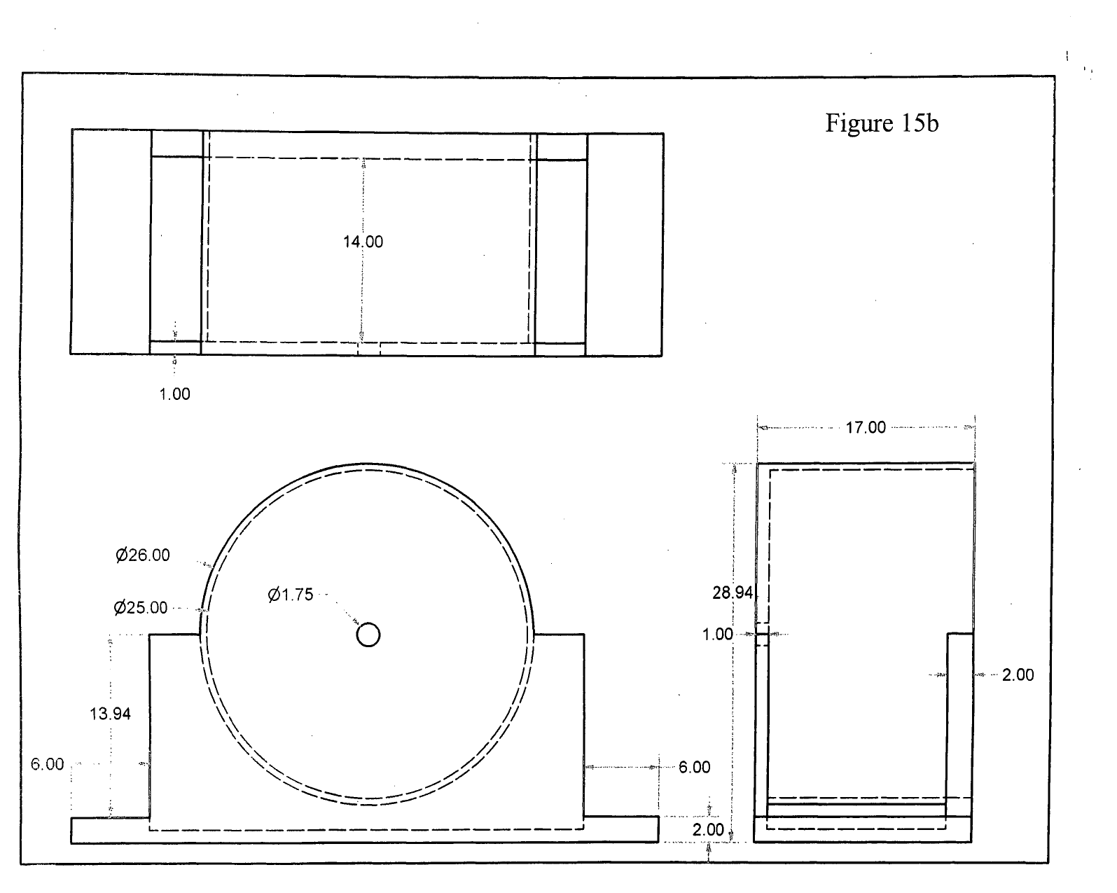

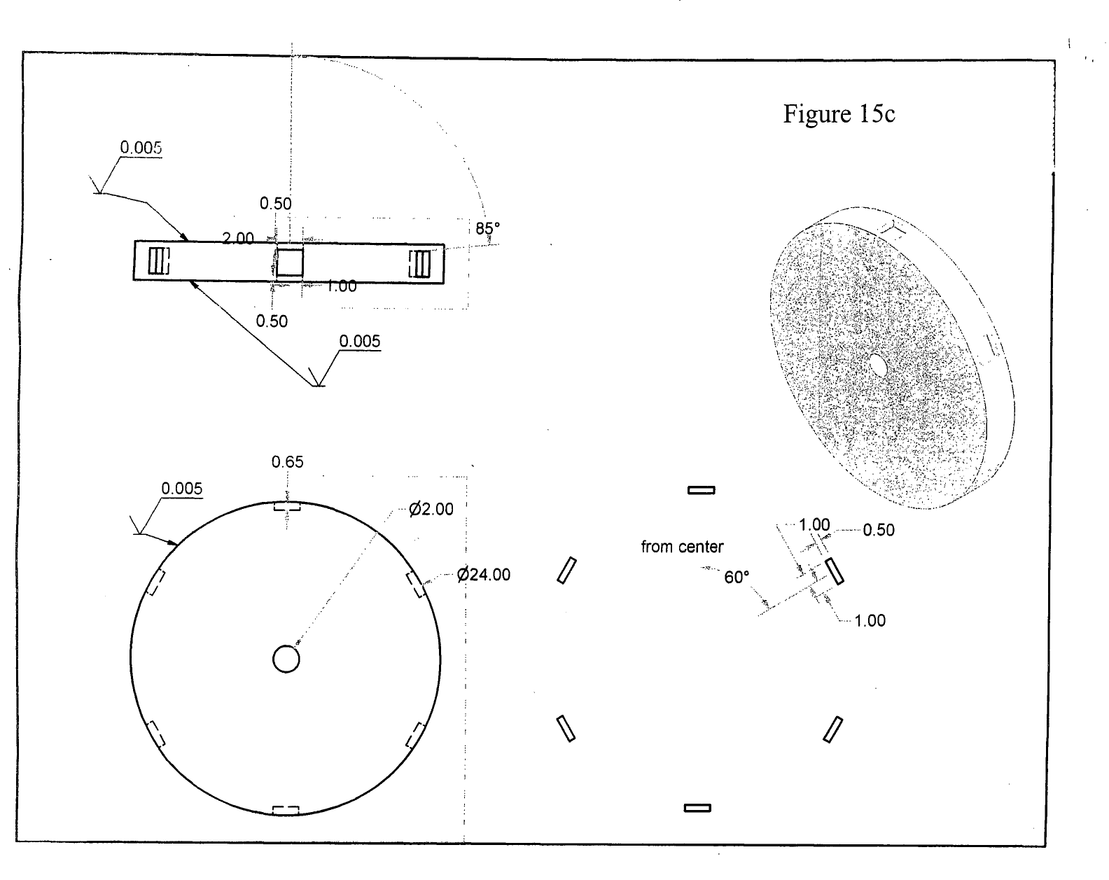

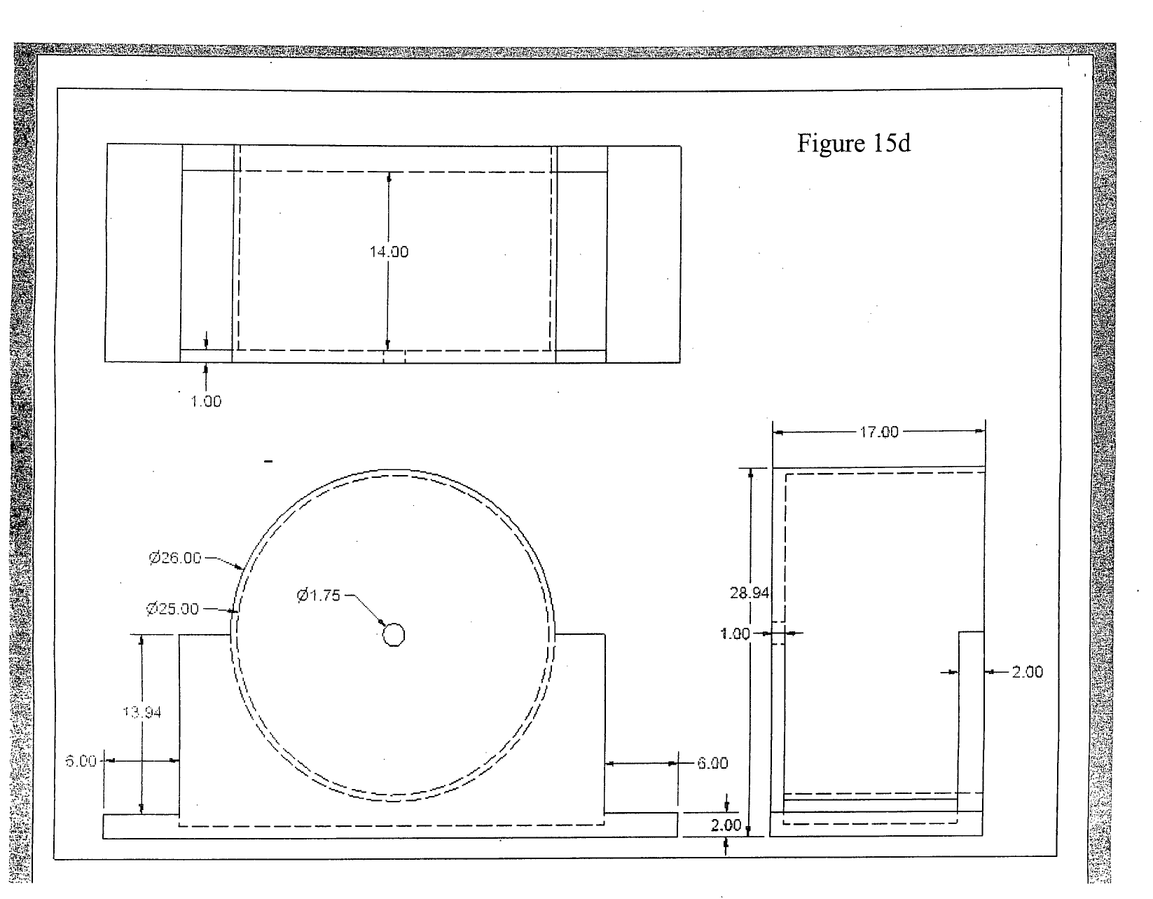

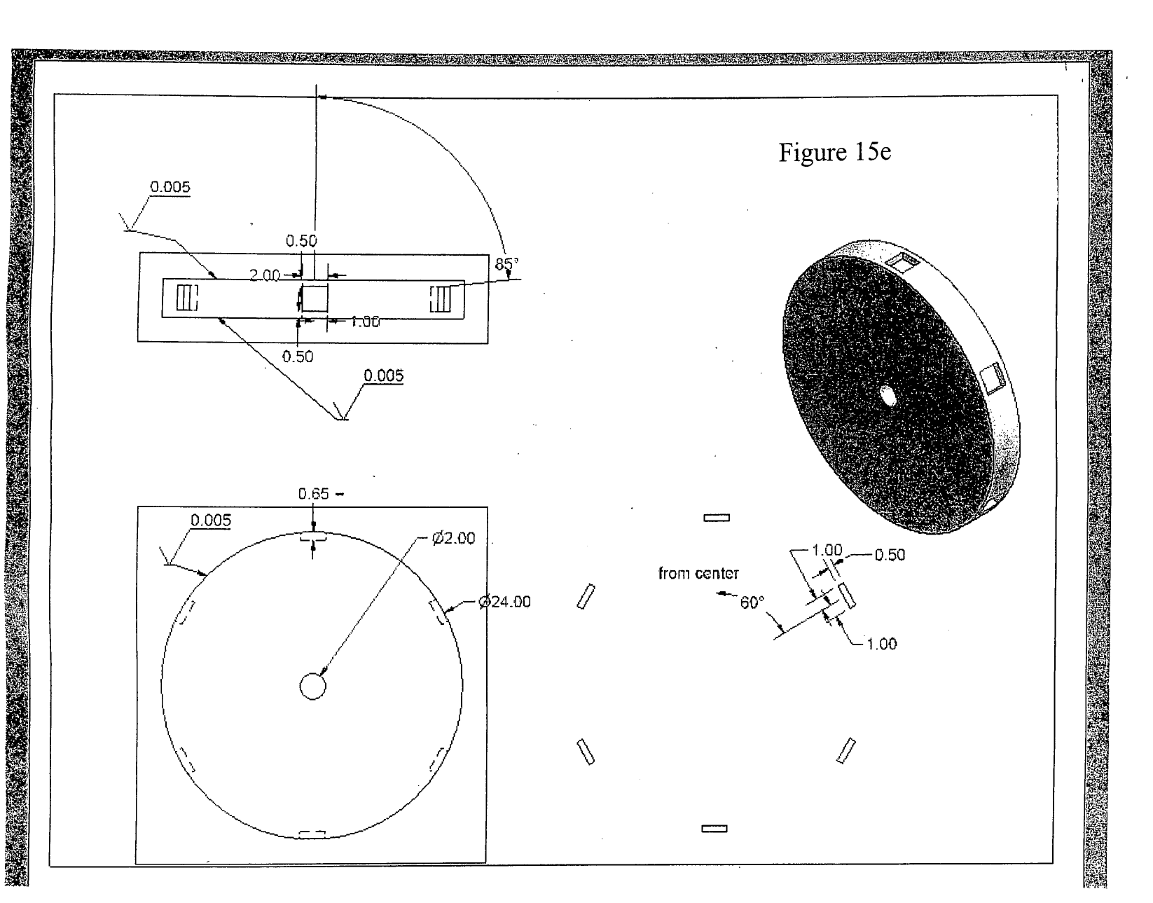

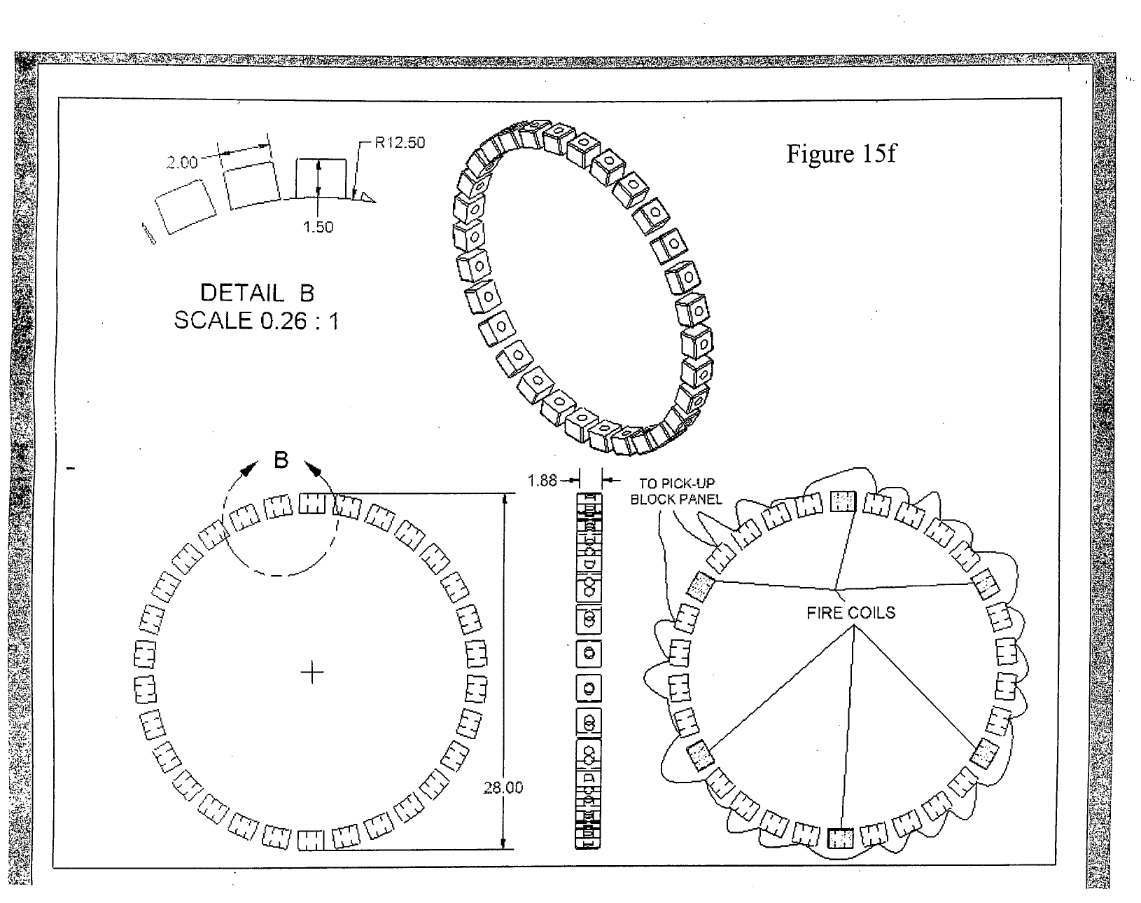

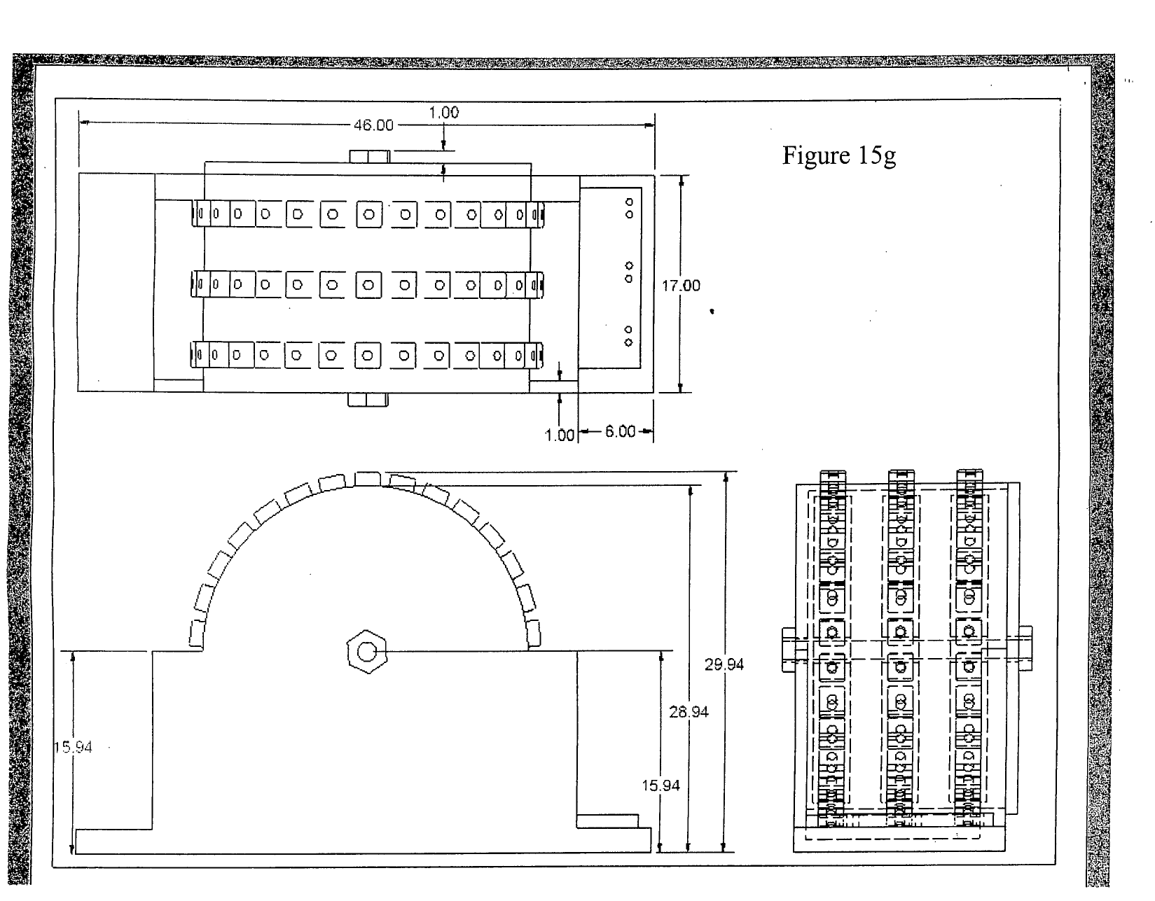

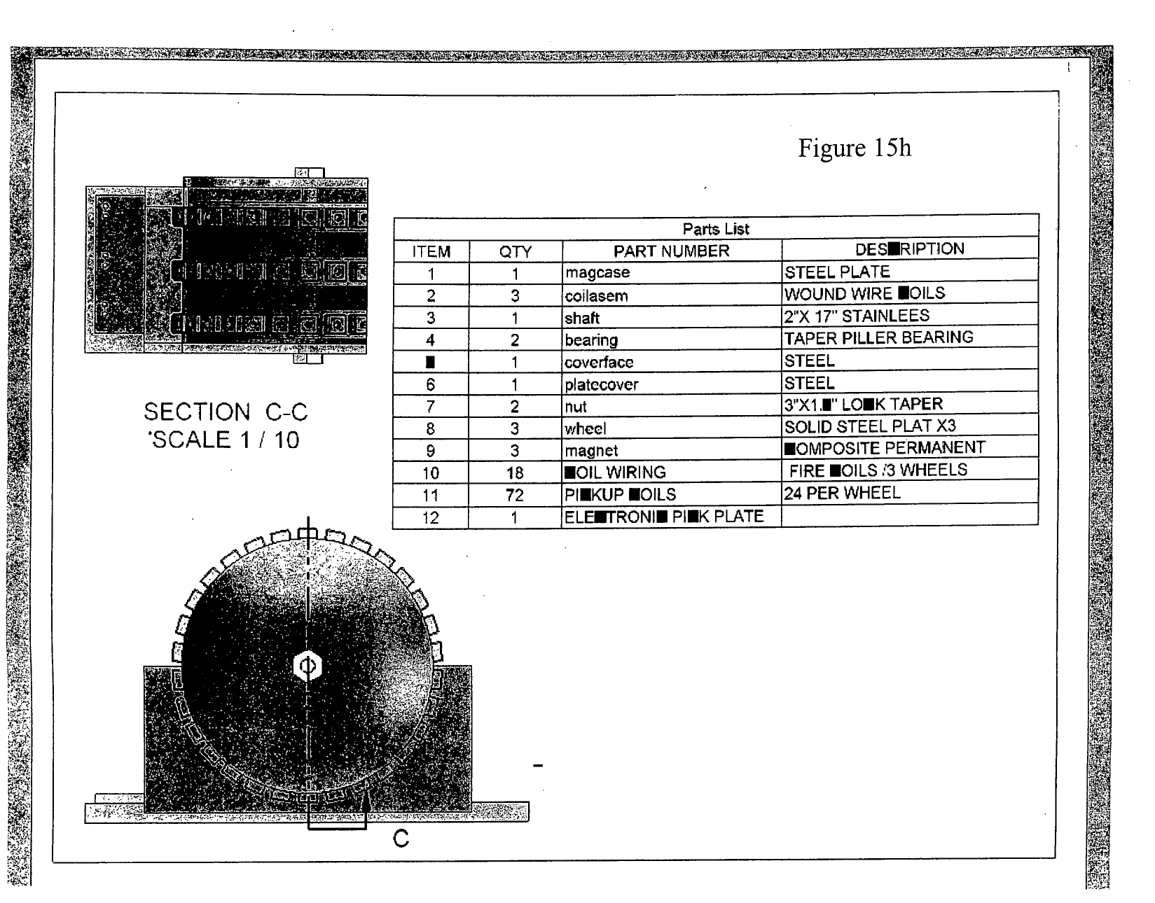

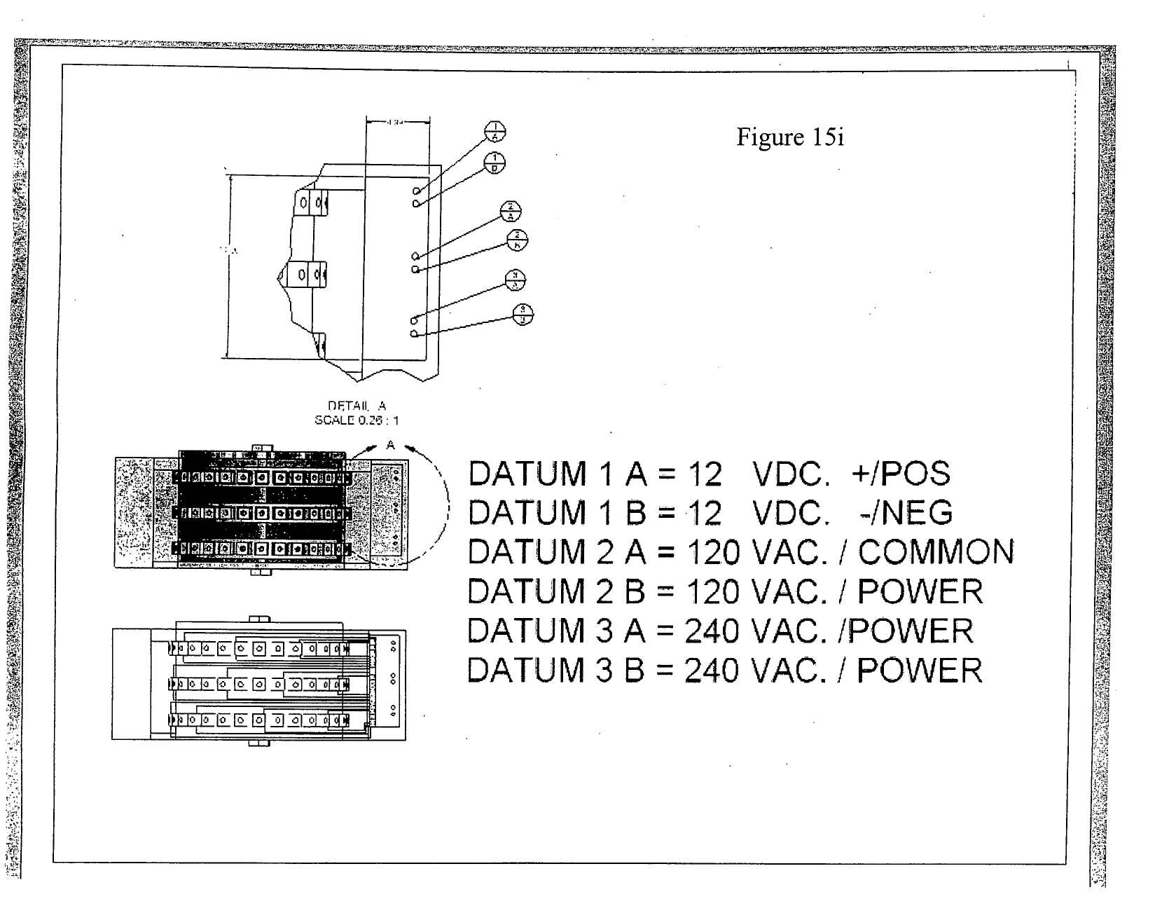

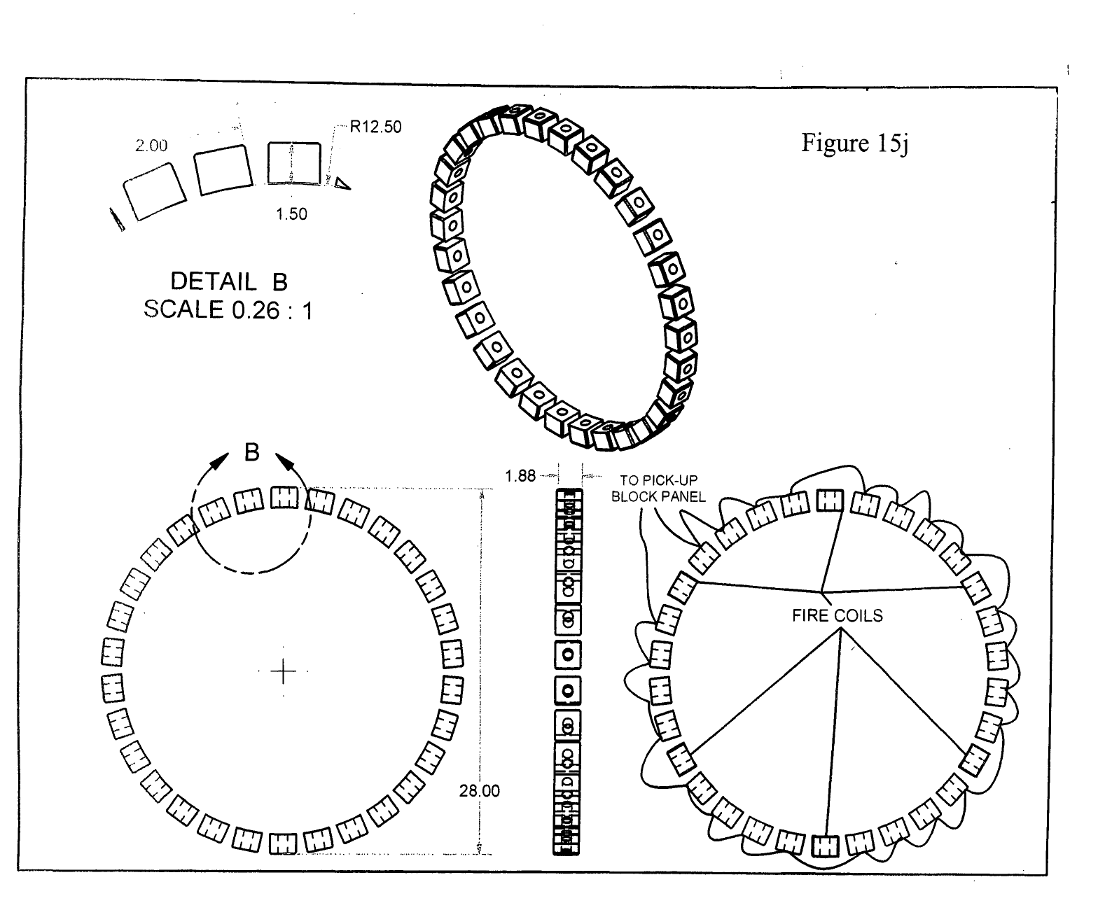

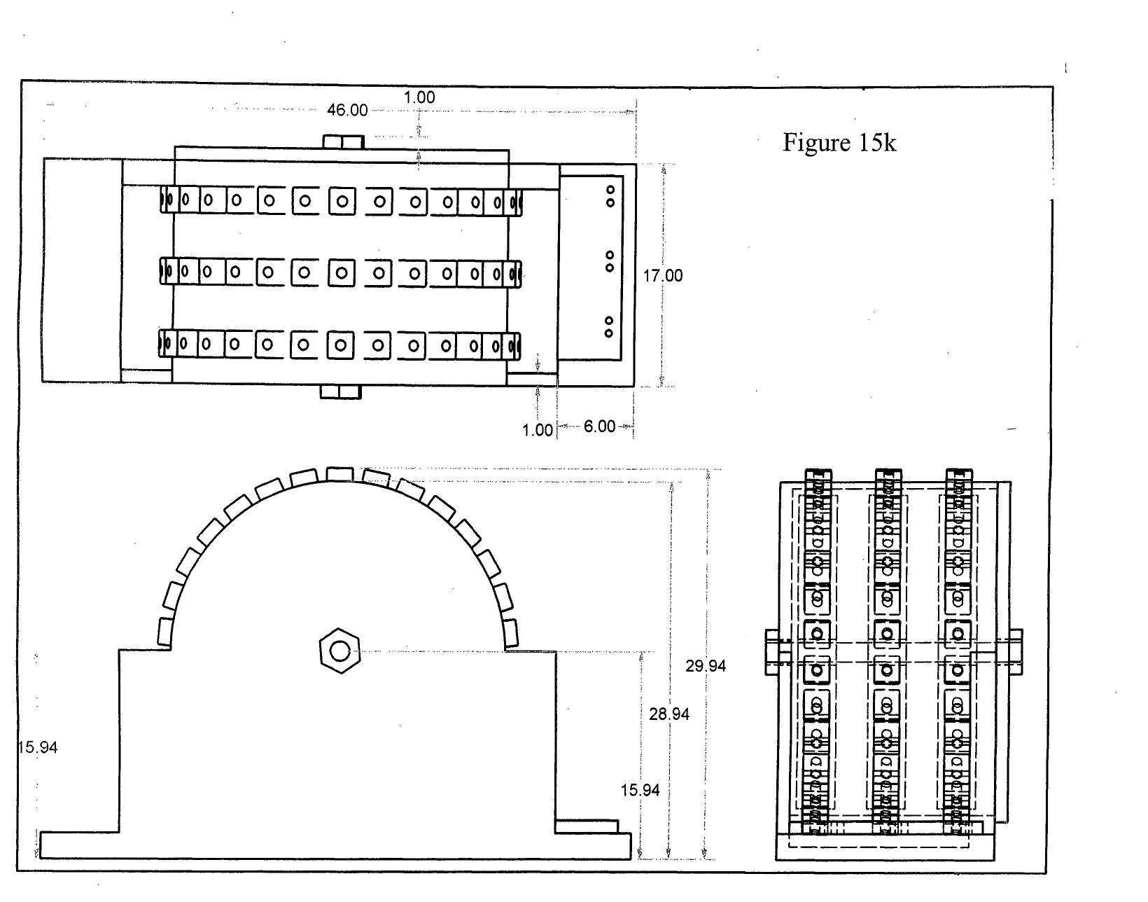

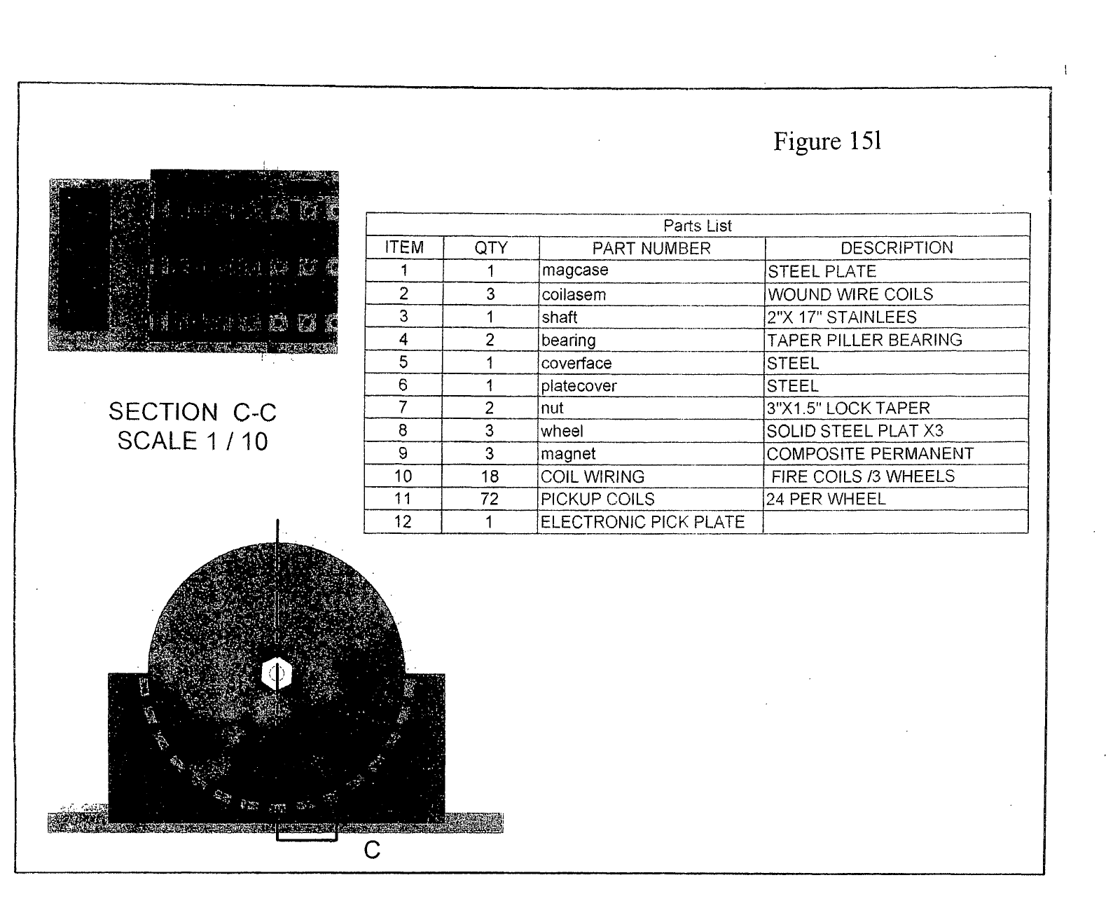

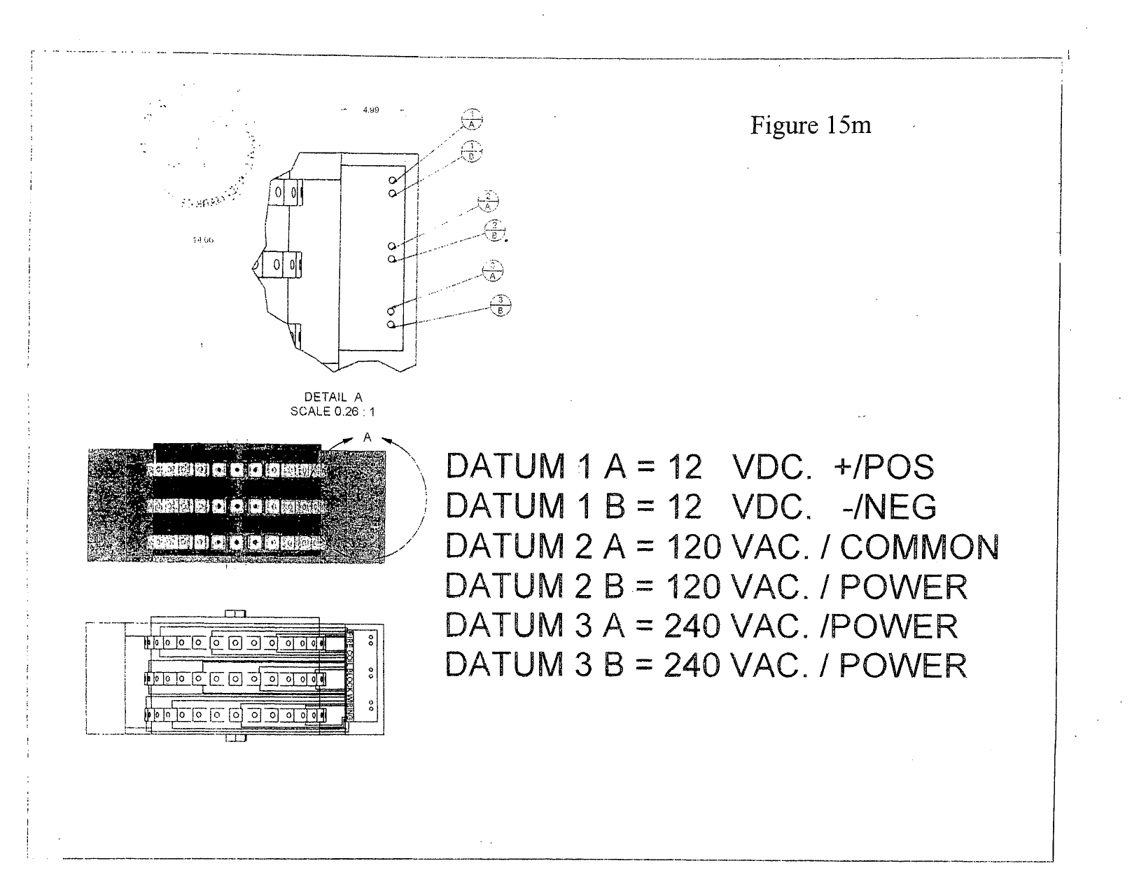

FIGS. 15a-m provide views of another working example of a magnetic motor according to an embodiment. FIGS. 15a-m provide exemplary structures, geometries, dimensions, and materials for constructing an example of the motor. The structures, geometries, dimensions, and materials are not to be considered as limitations of the present invention, but to serve as examples to demonstrate how one of ordinary skill in the art may reproduce an example of the motor.

The present invention relates to an efficient magnetic motor that implements magnets and coils to produce electrical power. The motor may be permanently mounted or the motor may be portable. For example, the motor may be designed to be carried by a person. The motor may be mounted or stored in a vehicle. The size of the motor may be varied in accordance with the desired use of the motor. The motor may be self-contained and may be designed to be virtually maintenance-free. The motor is environmentally friendly and the motor may be designed to produce little heat and noise. In this manner the motor may be designed to produce low or zero emissions of toxic fumes and/or radiation. Furthermore, the motor may be designed to have a low or zero signature. Therefore, the motor provides low risk when the motor is used for military applications, such as when the motor is used in the field by troops. Because the motor does not employ fossil fuels, there is low to zero explosive potential with the motor. The motor may include shielding to protect personnel susceptible to electrical fields, such as personnel with heart pacemakers. The motor may include few moving parts, reducing the operating costs of the motor to a minimum level.

Given the disclosure of the present invention, one versed in the art would appreciate that there may be other embodiments and modifications within the scope and spirit of the present invention. Accordingly, all modifications attainable by one versed in the art from the present disclosure within the scope and spirit of the present invention are to be included as further embodiments of the present invention.

What is claimed is:

1. A magnetic motor, comprising:
a rotor, wherein the rotor includes a center of rotation;
magnets, wherein the magnets are connected to the rotor; and
at least one coil;
wherein the at least one coil is arranged to be energized by a source of power to move the rotor through interaction of the at least one coil with the magnets and maintain the rotor at a predetermined operating speed or speeds within a predetermined operating range of speeds
and wherein the at least one coil is arranged to have an electrical current induced in the at least one coil by the magnets while the rotor is moving.

2. The magnetic motor of claim 1, wherein the magnets are connected to the rotor so that longitudinal axes of the magnets are at an angle with respect to respective planes plane passing through a rotation axis of the rotor and the center of gravity of respective magnets.

3. The magnetic motor of claim 1, wherein the magnets are arranged to move relative to the rotor.

4. The magnetic motor of claim 1, wherein the at least one coil includes two coils that are arranged proximate to an outer edge of the rotor, and wherein the two coils are arranged on opposite sides of the rotor.

5. The magnetic motor of claim 1, wherein the at least one coil includes a wrapping axis, wherein the at least one coil is arranged so that the wrapping axis is arranged at an angle to the center of rotation.

6. The magnetic motor of claim 1, wherein the at least one coil includes a wrapping axis, wherein the at least one coil is arranged so that the wrapping axis is arranged parallel to a plane in which the rotor lies.

7. The magnetic motor of claim 1, wherein the coils are arranged to be energized only when the magnets are in close proximity to the coils.

8. The magnetic motor of claim 1, wherein the at least one coil includes at least two energizing coils arranged relative to the rotor and an inductive coil arranged relative to the rotor so that an electrical current is induced in the inductive coil by the magnets while the rotor is moving.

9. The magnetic motor of claim 8, wherein the inductive coil includes a winding axis;
wherein the winding axis of the inductive coil is arranged vertically and normal to winding axes of the energizing coils.

10. The magnetic motor of claim 8, wherein the source of power is the inductive coil, wherein the inductive coil is arranged to power the energizing coils and the energizing coils are arranged to interact with the magnets to move the rotor.

11. The magnetic motor of claim 8, wherein the source of power is an external power source, wherein the motor is arranged so that when the external power source is disconnected from the motor the energizing coils maintain the predetermined operating speed or speeds within a predetermined operating range of speeds and the inductive coil is arranged to provide current to power the energizing coils.

12. The magnetic motor of claim 1, wherein the motor is arranged such that the source of power is effectively only the interaction of the at least one coil with the magnets.

13. The magnetic motor of claim 1, wherein the at least one coil is a plurality of coils, wherein individual coils of the plurality of coils are adapted to function as a coil arranged to be energized by a source of power to move the rotor through interaction of the at least one coil with the magnets and accelerate the rotor to the predetermined operating speed or the speed within the predetermined operating range of speeds and as adapted to function a coil arranged to have an electrical current induced in the at least one coil by the magnets while the rotor is moving.

14. The magnetic motor of claim 1, wherein the motor is arranged so that the predetermined operating speed or speeds within a predetermined operating range of speeds may be maintained with one coil.

15. The magnetic motor of claim 1, wherein the source of power is the at least one coil arranged to have an electrical current induced in the at least one coil by the magnets while the rotor is moving.

16. The magnetic motor of claim 1, wherein the motor is arranged to supply surplus power.

17. The magnetic motor of claim 1, wherein the motor is arranged so that coils having a current induced by the magnets produce greater current than current used to energize the at least one coil to rotate the rotor.

18. The magnetic motor of claim 1, further comprising a shaft that is mechanically coupled to the rotor.

19. The magnetic motor of claim 18, further comprising
a plurality of rotors attached to the shaft, wherein the rotors include magnets mounted to the rotors; and
coils arranged around the rotors, wherein the coils are arranged to be energized by a source of power to interact with the magnets and cause the rotor to rotate, wherein the coils are arranged to have a current induced in the coils by the magnets when the coils are not energized.

20. The magnetic motor of claim 19, wherein the coils are arranged to be periodically energize by the power source to maintain movement of the rotors at the predetermined operating speed or speed within the range of predetermined operating speeds, wherein the source of power is the coils that have an induced current by the magnets.

21. A power generating system, comprising:
a rotor, wherein the rotor includes a center of rotation;
magnets, wherein the magnets are connected to the rotor; and
at least one coil;
wherein the at least one coil is arranged to be energized by a source of power to move the rotor through interaction with the magnets and accelerate the rotor to a predetermined operating speed,
wherein the at least one coil is arranged to have an electrical current induced in the at least one coil by the magnets while the rotor is moving,
and wherein the system is arranged to power a vehicle, a residence, an industrial facility, industrial equipment, medical equipment, appliances, or farm equipment.

22. A method of operating a magnetic motor, comprising:
providing a magnetic motor that includes a rotor that includes a center of rotation, magnets that are connected to the rotor, and at least one coil, wherein the at least one coil is arranged to be energized by a source of power to move the rotor through interaction with the magnets and accelerate the rotor to a predetermined operating speed, wherein the at least one coil is arranged to have an electrical current induced in the at least one coil by the magnets while the rotor is moving;
energizing at least one coil to move the rotor through interaction of the at least one coil with the magnets and accelerate the rotor to a predetermined operating speed or a speed within a range of predetermined operating speeds;
periodically energizing at least one coil with a source of power to move the rotor through interaction of the at least one coil with magnets to maintain the rotor at the predetermined operating speed or speed within the predetermined operating speed;
collecting current from at least one coil arranged to have an electrical current induced in the at least one coil by the magnets while the rotor is moving; and
arranging the at least one coil arranged to have an electrical current induced in the at least one coil by the magnets while the rotor is moving as the source of power.

23. The magnetic motor of claim 9, wherein the motor is adapted such that when the source of power is only the inductive coil, the inductive coil powers the energizing coils and the energizing coils interact with the magnets to move the rotor.

24. The magnetic motor of claim 1, wherein the motor is arranged such that the source of power is only the interaction of the at least one coil with the magnets.

25. A method of operating a magnetic motor, comprising:
energizing at least a first coil of a magnetic motor that includes (i) a rotor having a center of rotation, (ii) magnets that are connected to the rotor, and (iii) a plurality of coils including the at least first coil, to rotate the rotor through interaction of the first coil with at least some of the magnets, wherein energy used to energize the at least first coil is obtained through induction from interaction between at least a portion of the magnets and at least a second coil of the plurality of coils.

26. The method of claim 25, wherein all the energy used to energize the at least first coil is entirely obtained through induction from interaction between the at least a portion of the magnets and the at least second coil of the plurality of coils, and wherein no other force beyond that created by energizing the at least first coil operates to rotate the rotor.

27. The method of claim 25, further comprising powering equipment solely using energy obtained through rotation of the rotor.
